(19) United States
(12) Patent Application Publication
(10) Pub. No.: US 2025/0390524 A1
(43) Pub. Date: Dec. 25, 2025

(54) SYSTEM AND METHOD FOR SEMANTICALLY CONTROLLING ASSET GENERATORS AND ASSETS

(71) Applicant: Unity Technologies SF, San Francisco, CA (US)

(72) Inventors: Kristofer David Schlachter, Old Greenwich, CT (US); Bay Leaf Raitt, Seattle, WA (US); Nicolas Lucien Perony, Zurich (CH); Michael James Sechrest, Chapin, SC (US); Dominic Laflamme, Hudson (CA); Benjamin Ahlbrand, Rolling Meadows, IL (US)

(21) Appl. No.: 19/244,532

(22) Filed: Jun. 20, 2025

Related U.S. Application Data
(60) Provisional application No. 63/662,950, filed on Jun. 21, 2024.

(51) Int. Cl. G06F 16/3332; G06F 16/338; G06T 15/00

(52) U.S. Cl. CPC G06F 16/3334; G06F 16/338; G06T 15/005

(57) ABSTRACT

System and method for determining sets of parameter values for asset generators, generating assets using the asset generators and the sets of parameter values, generating asset embeddings for asset representations, and storing the asset embeddings and one or more of the generated assets or asset generator information associated with the asset generators. The system receives query inputs and uses them to computes a query embedding. The system retrieves a set of asset embeddings matching the query embedding, each asset embedding being associated with a corresponding asset and/or asset generator information that includes an asset generator ID and/or a set of parameter values used to generate the asset. The system can display, in a user interface (UI), retrieved assets and/or asset generator information for further user-driven asset editing and/or asset regeneration. Asset representations and query inputs can span multiple modalities, such as natural language (NL) descriptions, images, and so forth.

### CROSS-REFERENCE TO RELATED APPLICATIONS

This application claims the benefit of U.S. Provisional Application No. 63/662,950, filed Jun. 21, 2024, entitled “SYSTEM AND METHOD FOR SEMANTICALLY CONTROLLING ASSET GENERATORS AND ASSETS,” which is incorporated by reference herein in its entirety.

### TECHNICAL FIELD

The disclosed subject matter relates generally to the technical field of computer graphics and, in one specific example, to a system for semantically controlling assets and/or asset generators.

### BACKGROUND

Modern asset generators for games, virtual worlds, design applications, simulations or any other asset-rich applications, are powerful systems with a variety of settings and/or options, complex user interfaces (UIs), and intricate control flows. Artists, designers and/or developers use such systems to produce a variety of assets that match complex task-specific constraints and/or artistic intents.

### BRIEF DESCRIPTION OF THE DRAWINGS

The patent or application file contains at least one drawing executed in color. Copies of this patent or patent application publication with color drawing(s) will be provided by the Office upon request and payment of the necessary fee.

Some embodiments are illustrated by way of example and not limitation in the figures of the accompanying drawings.

FIG. 1 is a network diagram illustrating a system within which various example embodiments may be deployed.

FIG. 2 is a diagrammatic representation of a system for controlling asset generators.

FIG. 3 is a flowchart illustrating a method implemented by a system for controlling asset generators.

FIG. 4 is an illustration of a UI screen of a system for semantically controlling asset generators.

FIG. 5 is an illustration of a UI screen of a system for semantically controlling asset generators.

FIG. 6 is an illustration of a UI screen of a system for semantically controlling asset generators.

FIG. 7 is an illustration of a UI screen of a system for semantically controlling asset generators.

FIG. 8 is an illustration of a UI screen of a system for semantically controlling asset generators.

FIG. 9 is an illustration of a UI screen of a system for semantically controlling asset generators.

FIG. 10 is an illustration of UI screens of a system for semantically controlling asset generators.

FIG. 11 is an illustration of UI screens of a system for semantically controlling asset generators.

FIG. 12 is an illustration of UI screens of a system for semantically controlling asset generators.

FIG. 13 is a block diagram illustrating an example of a software architecture that may be installed on a machine, according to some examples.

FIG. 14 is a block diagram illustrating a machine learning program, according to some examples.

FIG. 15 is a block diagram illustrating components of a machine, according to some examples, able to read instructions from a machine-readable medium (e.g., a machine-readable storage medium) and perform any one or more of the methodologies discussed herein.

### DETAILED DESCRIPTION

Modern asset generators for games, virtual worlds, design applications, planning simulations, and/or any other applications are powerful systems with a variety of settings and/or options, complex user interfaces (UIs), and/or intricate control flows. Asset generators can refer to any systems or processes resulting in the capture and/or production of images, text, video/audio/signal data, multimedia objects, templates for the generation of digital objects, software artifacts, and so forth. In some examples, asset generators are software packages that create objects (e.g. 3D objects), object templates, and/or other types of assets. Asset generators can be associated with a significant learning curve in part due to a large number of parameters and/or parameter settings used to characterize the type, appearance and/or behavior of generated assets. Furthermore, a user may need to control both a larger number of asset generators and/or a vast collection of available assets. Thus, there is a need for systems that enable fine-grained, unified control of a variety of asset generators and/or assets, and/or enable artists, designers and/or developers to produce and/or edit assets to match complex constraints or artistic intents without needing to learn a multitude of parametrization schemes or settings.

Example embodiments in the disclosure herein refer to a system for controlling assets and/or asset generators (e.g., 3D asset generators, etc.) that pre-computes, stores and/or searches a large number of asset generator outputs (e.g., assets or objects) and/or associated information. For example, given one or more asset generators, the system computes a large number of assets (or asset representations) using the asset generators and a set of automatically determined parameter settings. The system encodes the assets (or asset representations), and/or stores the resulting asset embeddings, the assets and/or the asset generator information (e.g., asset generator details, the parameter settings, etc.) for further use. The system can receive one or more query inputs from an end user and/or application programming interface (API), where the query inputs are related to a particular information need and/or span different input modalities (e.g., one or more natural language (NL) descriptions of an asset, one or more images representing the asset, etc.). The system can encode the received inputs and/or use the query input embeddings to compute a combined query embedding in the same embedding space as the stored asset embeddings. The system can search the stored asset embeddings using the query embedding, and/or return a result set of most relevant asset embeddings, assets, asset generators and/or corresponding parameter settings. The user and/or API can examine and/or further modify one or more of the returned assets and/or sets of parameter values for relevant asset generators as part of an effective, intuitive, and/or iterative interaction. As further detailed below, the system provides a general, fast, simple and/or unified interface and/or API for querying and/or interacting with multiple asset generators producing multiple types of assets and/or using different parametrization schemes. Any asset generator tool or asset synthesis tool can be incorporated in the set of asset generators as long as the assets can be described using natural language (NL) descriptions and/or rendered as images.

In some embodiments, the system for controlling asset generators determines sets of parameter values corresponding to parameters of one or more asset generators. The system generates assets using the one or more asset generators and the determined sets of parameter values. The system can produce representations of the generated assets using one or more representation models such as a shaded rendering model, a stylized rendering model, a sketch model, a text captioning model, and so forth. In some embodiments, the system produces, using one or more encoding models, embeddings for the representations of the generated assets. The system stores these asset embeddings, the corresponding assets (or asset representations) and/or information associated with the used asset generators. Such information can include asset generator IDs, the determined sets of parameter values used for asset generation, and so forth. In some embodiments, the system uses a database (DB) or other local or cloud storage options. The one or more encoding models used by the system can include text encoders, image encoders, joint text and image encoders, and so forth.

In some embodiments, the system receives, via a user interface (UI) or via an API, a set of query inputs. The query inputs can use one or more input modalities: image inputs (e.g., photos, photorealistic images, non-photorealistic (NPR) images, sketches, etc.), natural language (NL) inputs, and so forth. The system can access and/or receive one or more weights. In some embodiments, weights are associated with query inputs. The system can generate embeddings of the query inputs using one or more encoding models (e.g., a joint text and image encoding model, etc.) The system can generate a unified query embedding using the embeddings of the query inputs, the weights, and/or a combination function (e.g., a linear combination function). Given the query embedding, the system can retrieve a set of stored asset embeddings that are relevant to the query embedding (with respect to a predefined relevance function). For example, the system can return a set of stored asset embeddings that best match the query embedding, with respect to a predefined matching function. In some embodiments, the system can compute a similarity metric (such as cosine similarity, etc.) between the query embedding and the stored asset embeddings. The system can return the top K most similar asset embeddings (where K is a predefined constant, K≥1) to a user or to a querying API. In some embodiments, the system returns, for each retrieved asset embedding, the corresponding asset and/or the information corresponding to the asset generator used to generate the asset. For example, the system returns an asset generator ID (or asset generator name), the set of parameter values used by the asset generator with the respective ID to generate the asset, and so forth. Thus, the system enables a user or API to search the space of asset generators based on the semantics of their output and/or only interact with specific asset generator parameters—if needed—once an asset of interest has been retrieved. In some embodiments, the user and/or API can remain agnostic to the space of the algorithms used to generate the object—for example, if at least one of the retrieved assets satisfies an input query, no further interaction with asset generator parameters may be necessary.

In some embodiments, the system displays, via the UI, the retrieved assets associated with the set of retrieved asset embeddings matching the query embedding. Upon receiving, via the UI or via an API, a selection of an asset associated with an asset embedding of the set of retrieved asset embeddings, the system retrieves the asset generator ID and/or the corresponding set of parameter values associated with the asset and asset embedding. Upon detecting an editing operation associated with the asset, the system updates the set of parameter values based on the user editing operation, and/or stores the updated set of parameter values and/or the edited asset.

In some embodiments, upon retrieving the asset generator ID and corresponding set of parameter values associated with an asset and asset embedding, the system displays, in the UI, the asset and/or the corresponding set of parameter values. Upon receiving one or more updates to the displayed set of parameter values, the system can store the updated set of parameter values. The system can generate an updated asset using an asset generator with the corresponding asset generator ID and the updated set of parameter values. The system can store the updated asset and/or one or more of the asset generator ID and the updated set of parameter values.

Overall, example embodiments in the disclosure herein refer to a system that enables control and/or management of asset generation, which is particularly useful in gaming, virtual reality, design applications, simulations, and so forth. The system features a UI that supports multiple input modalities, including natural language and images, enabling users to intuitively interact with the system to query and retrieve assets produced by a variety of asset generators with a variety of parameter options. The system can use machine learning (ML) models and/or search technologies to pre-compute, store, and efficiently search a vast repository of asset generator outputs and/or otherwise available assets. Assets can be linked to specific parameter settings, allowing for precise and controlled asset generation, retrieval, modification and/or re-generation. Thus, the system enables users to retrieve and/or generate assets that closely align with their specific requirements and constraints. Additionally, the system accommodates near real-time modifications to assets. Users can adjust parameter settings and/or see and/or further modify the regenerated assets, facilitating a highly interactive and iterative design process. The system thus enables users to fine-tune assets quickly and efficiently, significantly enhancing productivity and/or creative flexibility in asset creation.

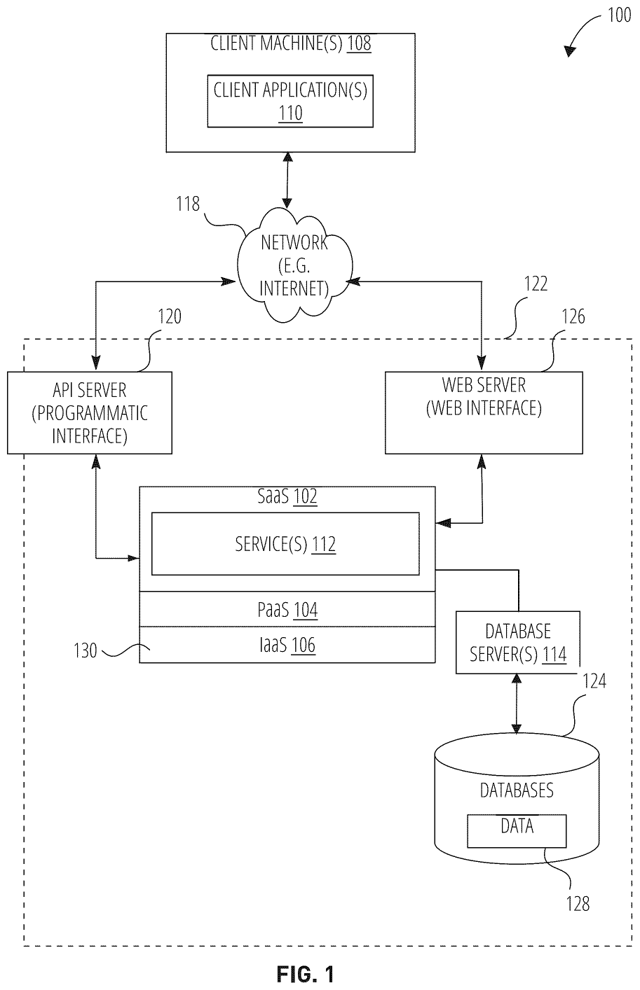

FIG. 1 is a network diagram depicting a system 100 within which various example embodiments described herein may be deployed. A networked system 122 in the example form of a cloud computing service, such as Microsoft Azure or other cloud service, provides server-side functionality, via a network 118 (e.g., the Internet or Wide Area Network (WAN)) to one or more endpoints (e.g., client machine(s) 108). FIG. 1 illustrates client application(s) 110 on the client machine(s) 108. Examples of client application(s) 110 may include a web browser application, such as the Internet Explorer browser developed by Microsoft Corporation of Redmond, Washington or other applications supported by an operating system of the device, such as applications supported by Windows, iOS or Android operating systems. Examples of such applications include e-mail client applications executing natively on the device, such as an Apple Mail client application executing on an iOS device, a Microsoft Outlook client application executing on a Microsoft Windows device, or a Gmail client application executing on an Android device. Examples of other such applications may include calendar applications, file sharing applications, contact center applications, digital content creation applications (e.g., game development applications) or game applications. Each of the client application(s) 110 may include a software application module (e.g., a plug-in, add-in, or macro) that adds a specific service or feature to the application.

An API server 120 and a web server 126 are coupled to, and provide programmatic and web interfaces respectively to, one or more software services, which may be hosted on a software-as-a-service (SaaS) layer or platform 102. The SaaS platform may be part of a service-oriented architecture, being stacked upon a platform-as-a-service (PaaS) layer 104 which, may be, in turn, stacked upon an infrastructure-as-a-service (IaaS) layer 106 (e.g., in accordance with standards defined by the National Institute of Standards and Technology (NIST)).

While the applications (e.g., service(s)) 112 are shown in FIG. 1 to form part of the networked system 122, in alternative embodiments, the applications 112 may form part of a service that is separate and distinct from the networked system 122.

Further, while the system 100 shown in FIG. 1 employs a cloud-based architecture, various embodiments are, of course, not limited to such an architecture, and could equally well find application in a client-server, distributed, or peer-to-peer system, for example. The various server services or applications 112 could also be implemented as standalone software programs. Additionally, although FIG. 1 depicts machine(s) 108 as being coupled to a single networked system 122, it will be readily apparent to one skilled in the art that client machine(s) 108, as well as client application(s) 110 (such as game applications), may be coupled to multiple networked systems, such as payment applications associated with multiple payment processors or acquiring banks (e.g., PayPal, Visa, MasterCard, and American Express).

Web applications executing on the client machine(s) 108 may access the various applications 112 via the web interface supported by the web server 126. Similarly, native applications executing on the client machine(s) 108 may access the various services and functions provided by the applications 112 via the programmatic interface provided by the API server 120. For example, the third-party applications may, utilizing information retrieved from the networked system 122, support one or more features or functions on a website hosted by the third party. The third-party website may, for example, provide one or more promotional, marketplace or payment functions that are integrated into or supported by relevant applications of the networked system 122.

The server applications may be hosted on dedicated or shared server machines (not shown) that are communicatively coupled to enable communications between server machines. The server applications 112 themselves are communicatively coupled (e.g., via appropriate interfaces) to each other and to various data sources, so as to allow information to be passed between the server applications 112 and so as to allow the server applications 112 to share and access common data. The server applications 112 may furthermore access one or more databases 124 via the database server(s) 114. In example embodiments, various data items are stored in the databases 124, such as the system's data items 128. In example embodiments, the system's data items may be any of the data items described herein.

Navigation of the networked system 122 may be facilitated by one or more navigation applications. For example, a search application (as an example of a navigation application) may enable keyword searches of data items included in the one or more databases 124 associated with the networked system 122. A client application may allow users to access the system's data 128 (e.g., via one or more client applications). Various other navigation applications may be provided to supplement the search and browsing applications.

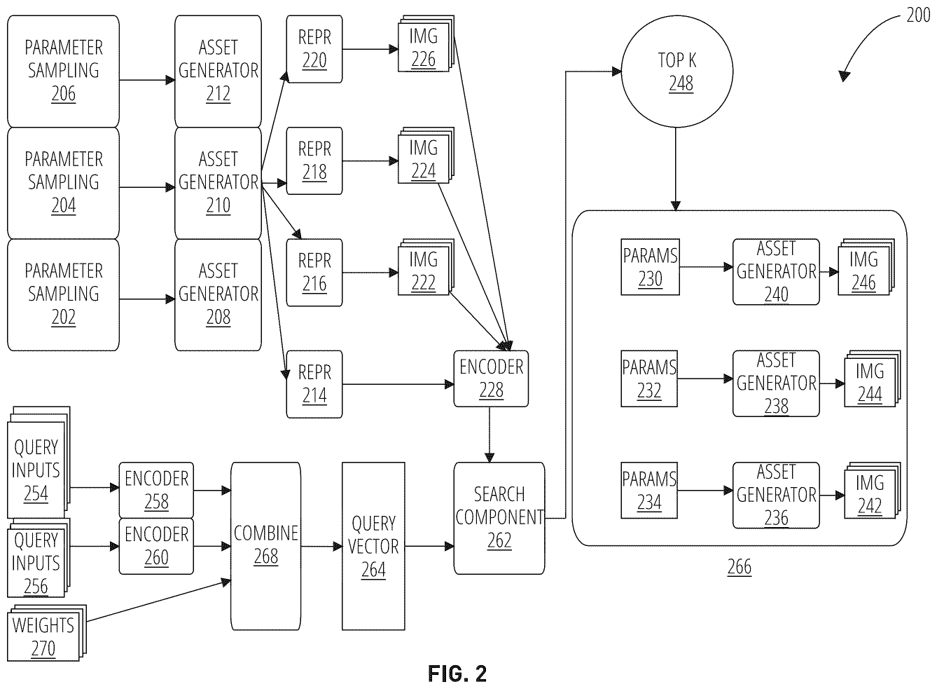

FIG. 2 is a diagrammatic representation of a system 200 for controlling asset generators and/or assets. Asset or object generators generically refer to any systems or processes that capture and/or output or produce text data, images, video data, audio or sound data, signal data, multimedia objects, software artifacts, templates for generating any of the previously enumerated types of object or combinations thereof, and so forth (see, e.g., GLOSSARY for additional examples of assets.) Asset generators can include procedural systems, probabilistic and/or machine learning (ML) systems, and so forth. In some embodiments, asset generators can be software packages that create objects (e.g. 3D objects), object templates and/or Unity prefabs, and other assets. For example, asset generators can include building generators (creating specific types of 3D buildings), gun generators (creating specific types of 3D guns), island generators (creating specific types of 3D islands), axe generators (creating specific types of 3D axes), and so forth.

In some embodiments, asset generators are associated with a number of parameters and/or parameter settings that can be used to characterize the type, appearance and/or behavior of a generated asset. In some embodiments, this number of parameters and/or parameter settings can be large, leading to a significant learning curve for the respective asset generators.

The design of the system 200 for controlling asset generators and/or assets is informed by the intuition that it is possible to pre-compute, store and/or search a large number of asset generator outputs (e.g., assets or objects), each output associated with a set of parameter values for the one or more asset generators. A set of parameter values (e.g., corresponding to a parameter setting) used to produce an asset (or asset representation) can be associated with an embedding of that asset (or asset representation) that is stored for further use. System 200 can receive a query from an end user and/or API, and return a result set of relevant assets, object generators and/or corresponding parameter settings. The user and/or API can examine and/or further modify one or more of the returned assets, object generators and/or sets of parameter values as part of an effective, intuitive, and/or iterative interaction. Thus, system 200 enables semantically controlling a large number of assets and/or a variety of asset generators with a variety of parametrization schemes by generating and/or using a common encoding space for the assets and/or for received queries.

In some embodiments, system 200 uses one or more parameter sampling components (e.g., 202, 204, 206). Given an example asset generator system, a parameter sampling component (e.g., 202) samples one or more of the parameters of the asset generator system. In some embodiments, this sampling results in an instance of the asset generator (e.g., asset generator 208) characterized by a set of (sampled) parameters and their associated values. Each such asset generator instance is associated, in some embodiments, with an output corresponding to a produced asset: an object (such as a 3D object), an object template (e.g., a 3D object template, such as a Unity prefab), or other assets.

In some embodiments, system 200 can use and/or include asset generators if they are sufficiently parametrized according to one or more parametrization criteria that take into account the number of parameters and the cardinality of parameter value sets. For example, an asset generator with more than N parameters (N=constant, N>=1) where at least K of the N parameters have at least M values (K, M being predetermined constants), can be determined to be sufficiently parametrized. On the other hand, an asset generator such as a skybox generator that has one parameter with two possible states (e.g., {“sunny,” “overcast”}) can be determined to insufficiently parametrized. In some embodiments, the system 200 can compute a quantitative measure (e.g., cumulative explained variance or other explained variance metrics) for one or more of the parameters associated with an asset generator in the context of the dataset represented by the set of possible asset generator outputs. If quantitative measure values for the one or more parameters transgress a predetermined threshold, the asset generator can be determined to be insufficiently parametrized. For example, in the case of the skybox generator above, sampling the values of the one parameter with only 2 possible values can lead to a reduction in dimensions too large to be useful, and therefore the asset generator may be left out of the set of asset generators used by the system 200.

Given an asset generator (e.g., asset generator 208) instantiated with a particular parameter setting, and/or an associated produced asset, system 200 uses one or more representation generators (e.g., repr 214 through 220, etc.) to generate asset representations. Representation generators can produce one or more of the following representations: standard shaded renders, highly stylized renders (e.g., toon-like shading, outlines, silhouettes, the outputs of other non-photorealistic rendering (NPR) methods), hand-drawn sketches, text captions generated by a captioning model (e.g., a ML captioning model), and so forth. Asset representation outputs can thus include images (e.g., IMG 222 through IMG 226, etc.), text, and/or other types of media. The system 200 uses one or more encoder components, such as encoder 228, to generate embeddings of the produced representations. The one or more encoding models used by the system can include text encoders, image encoders, joint text and image encoders or cross-modality and/or multi-modality encoders (e.g., models such as CLIP (Contrastive Language-Image Pre-training), VILBERT, VisualBert, Unified VLP, and so forth). Each asset produced by an asset generator (e.g., asset generator 208) has a corresponding representation that is converted, using an encoder, to an embedding. System 200 stores one or more of the computed asset representation embedding, the asset representation (e.g., a render of a 3D asset) and/or the asset generator information (e.g., a name and/or ID for an asset generator or asset generator instance and/or the set of parameter values used to produce the asset.)

In some embodiments, system 200 receives as input one or more query inputs (e.g., sec 254, 256) corresponding to images and/or natural language (NL) descriptions and/or input (e.g., text input, voice input, etc.). Images can be at various levels of abstraction (e.g., sketches, stylized abstractions such as cartoon, painter style and so forth, photographs). Thus, query inputs can be received in one or more input modalities. In some examples, an input can correspond to a linear combination of one or more input modalities. In some embodiments, system 200 receives as inputs one or more weights, each weight corresponding to a relative importance associated with an input modality, and/or with a particular query input of a specific input modality (e.g., a particular image, a particular NL description, and so forth). In some embodiments, the query inputs and/or the weights can be received via a UI, and/or via an API call. Given a query input, system 200 can use an image and/or text encoder (e.g., encoder 258, encoder 260, etc.) to compute an embedding of the respective query input. In some examples, system 200 can use a joint text and image encoder, and/or a cross-modality encoder. System 200 uses a combine 268 component to generate a combined embedding of the received query inputs (e.g., query vector 264), where the weights 270 are used to determine the relative importance of query input embeddings. The combined embedding can be generated using a combination function (e.g., a linear combination function, etc.). Note that while query images can depict an asset or object at different levels of abstraction, the system will map such representations, as well as natural language descriptions of the object or asset to the same, unified embedding space (e.g., if necessary, using a joint text and image encoder or cross-modality encoder, as described above, etc.). System 200 ensures that the query input embeddings use the same embedding space as the stored asset embeddings. Given the unified embedding space, asset representations and or query inputs that have similar semantics (e.g., a “red mug” text string and an image of a red mug, etc.) will be close by with respect to a distance metric based on the distance between embedding vectors.

Given a query vector 264, system 200 can compute, via search component 262, a distance between an input query vector (e.g., query vector 264) and one or more of the stored embeddings of the object representations (e.g., compute a cosine similarity metric, etc.). The search component 262 can use a K-nearest neighbors method (KNN) to determine and/or retrieve a set of K stored asset representation embeddings that are closest and/or most similar to the query embedding vector 264. Each retrieved asset embedding is associated with an asset or asset representation (e.g., a render of a 3D asset), and/or information corresponding to the asset generator used to generate the asset. For example, asset generator 240 can be an instance of an asset generator associated with a set of sampled parameters 230 (e.g., a set of determined parameter values). When asset generator 240 is initialized and/or executed with the set of parameters 230, the result is an asset (e.g., IMG 246) whose embedded representation satisfies the search criterion (e.g., similarity or relevance to the query vector 264).

In some embodiments, the system 200 displays, via the UI, a set of search results corresponding to the set of provided query inputs. Each search result can include one or more of an asset representation for an asset (e.g., IMG 246, corresponding for example to a 3D rendering of an asset), the asset representation embedding, information about the asset generator that produced the asset, and so forth. In some embodiments, the information about the asset generator includes an asset generator ID or name and/or the set of parameter values used for asset generation by the asset generator with the respective ID or name (e.g., the employed parameter setting). If the system 200 detects a user selection of an asset representation and/or a user editing operation applied to the asset representation, the system can automatically update the parameter values used by the asset generator to reflect the user-required changes to the asset appearance and/or functionality. In some embodiments, the asset representation selection and/or editing can be detected to correspond to one or more API calls to the system 200. In some embodiments, the system detects direct updates to the set of parameter values used by the asset generator to generate the asset. The system can re-run the asset generator using the updated set of parameter values, producing an updated version of the asset. Thus, the system 200 can enable asset customization. Alternatively, the user and/or API can re-issue a query. Upon receiving an updated query and/or search, the system 200 can retrieve a new set of search results.

In some embodiments, system 200 can access already existing assets and/or asset representations (e.g., a vast collection of existing assets or assets representations). System 200 can use the one or more encoding models to generate asset embeddings, and/or store the asset embeddings for further use. Upon receiving query inputs and/or generating a query embedding as described above, system 200 can retrieve a set of stored asset embeddings that includes asset embeddings for such already existing assets. While the respective asset embeddings and/or assets may not include a parameter setting or asset generator provenance information, a requesting user and/or API can directly retrieve, display, edit, and/or use the assets as part of downstream tasks.

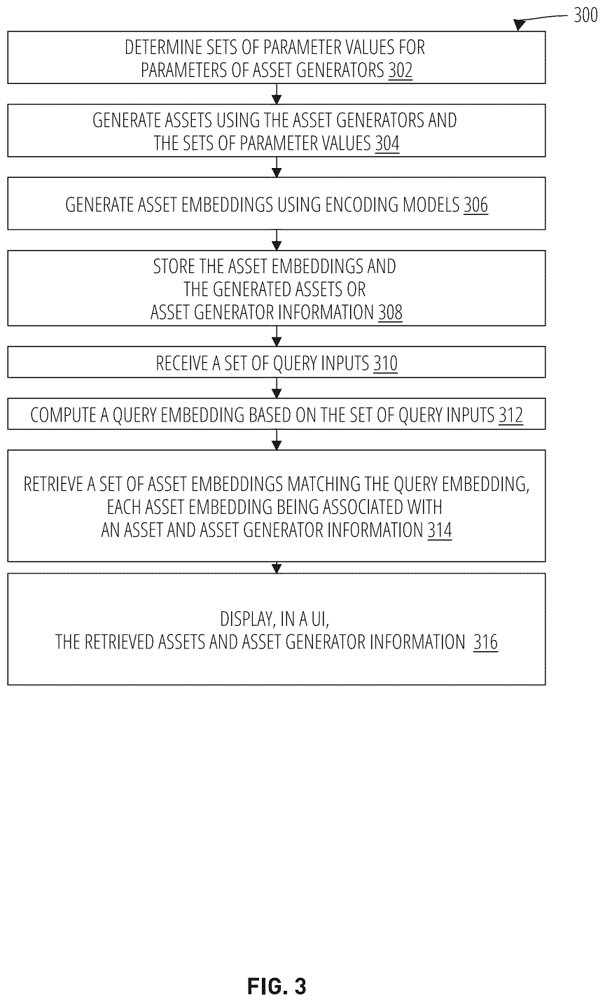

FIG. 3 is a flowchart illustrating a method 300 implemented by system 200 for semantically controlling asset generators. At operation 302, system 200 determines, at a computing device, one or more sets of parameter values for parameters of asset generators. At operation 304, system 200 generates assets using one or more of the determined sets of parameter values and the corresponding asset generators. At operation 306, system 200 generates, using one or more encoding models, asset embeddings for the generated assets. At operation 308, system 200 stores the asset embeddings and one or more of the generated assets or asset generator information associated with the asset generators. At operation 310, system 200 receives a set of query inputs. At operation 312, system 200 computes a query embedding using the set of query inputs. At operation 314, system 200 retrieves a set of asset embeddings matching the query embedding, each asset embedding in the set of asset embeddings being associated with a corresponding asset and/or corresponding asset generator information. At operation 316, system 200 displays, in a UI, the retrieved assets and/or the corresponding asset generator information for further interaction.

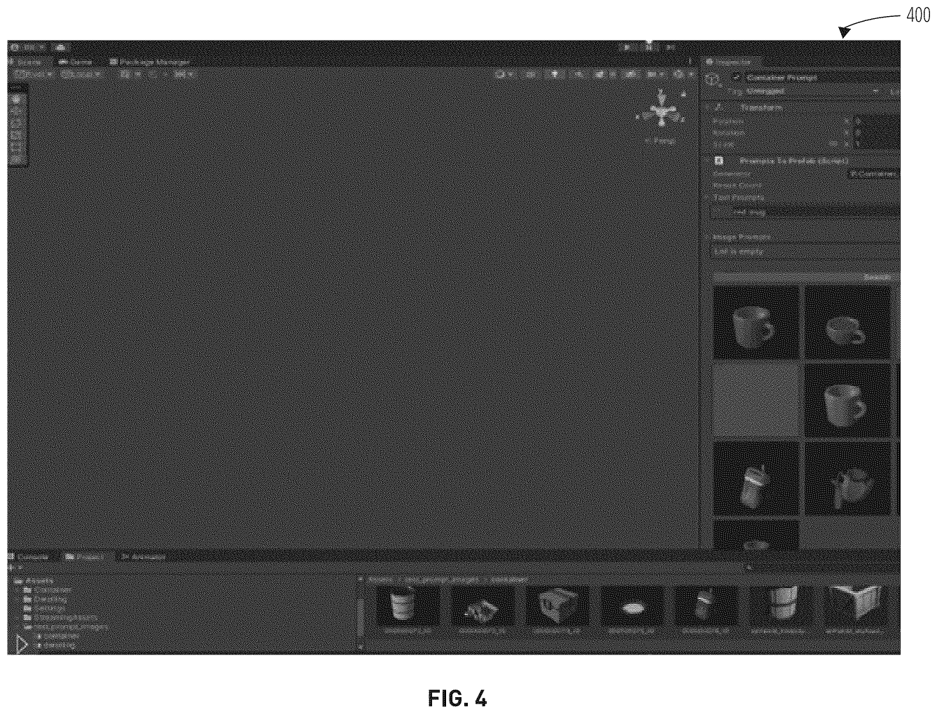

FIG. 4 is an illustration 400 of a UI screen for a system 200 for semantically controlling asset generators. The system 200 is enabled to receive natural language inputs and/or image inputs. Here, system 200 receives a natural language description of “red mug”, while the image input set is empty. The system 200 constructs a query vector (as detailed in FIG. 2), and retrieves a set of K asset embeddings and/or assets matching the received input (here, a series of images of red and/or red-tinted mugs, etc.). As detailed in FIG. 2, each retrieved asset embedding is associated with a corresponding asset, an asset generator name and/or ID, and/or a set of parameter values corresponding to the parameter setting that leads an asset generator with the respective name or ID to produce the asset.

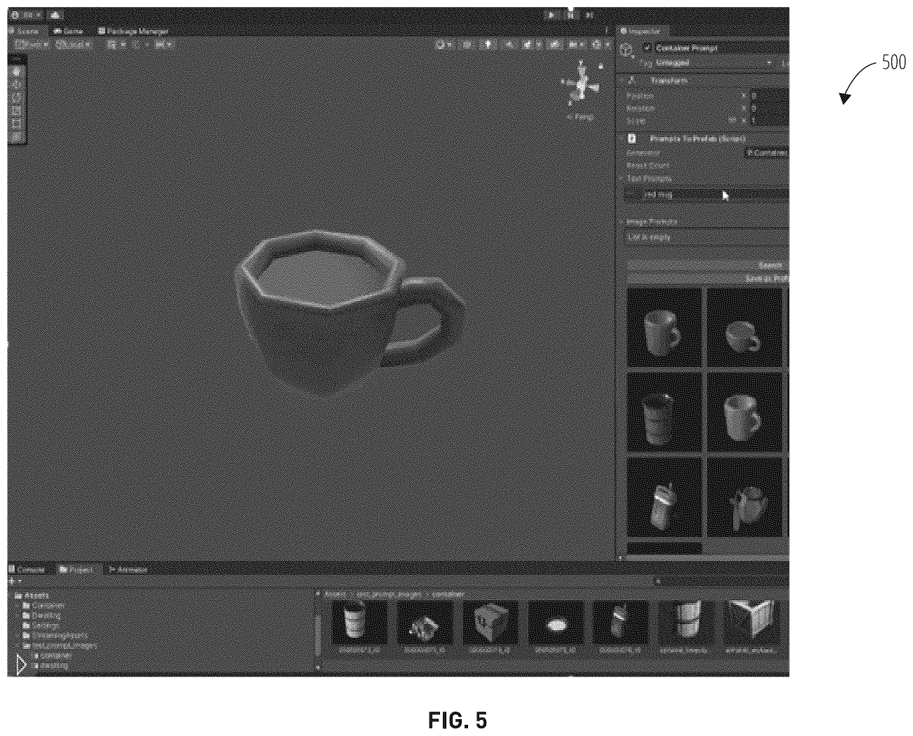

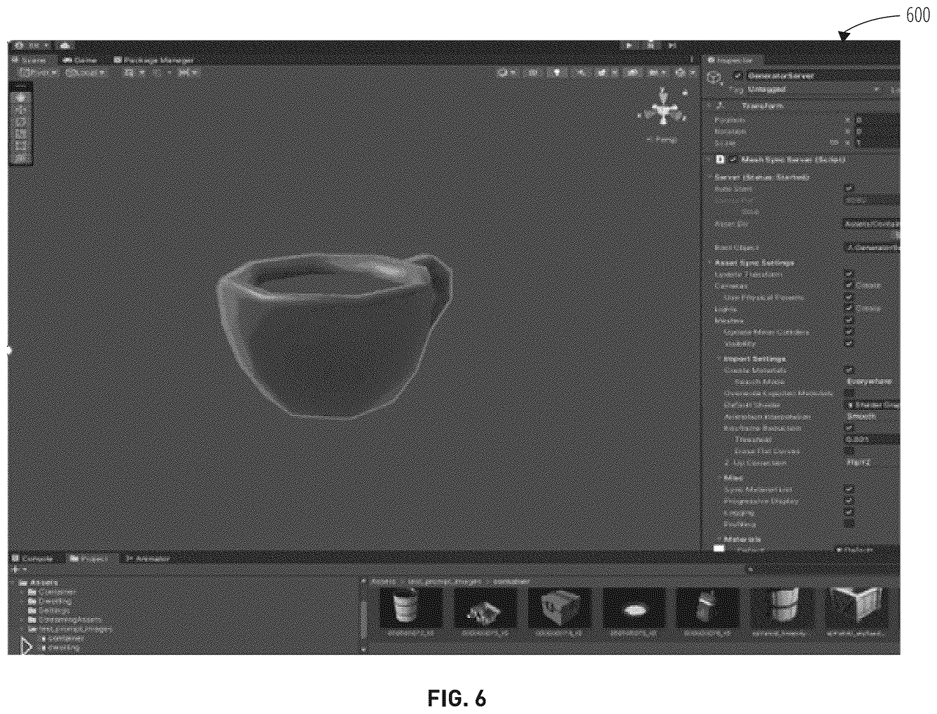

FIG. 5 is an illustration 500 of a UI screen for a system 200 for semantically controlling asset generators. After system 200 returns a set of assets matching a user search for a red mug (see FIG. 4), the user can select one of the matching assets. Upon receiving a user selection of one of the returned results, system 200 displays the asset in the UI screen, enabling further manipulation and/or customization of the asset. As detailed in FIG. 2, each asset is associated with the asset generator that produced it and/or with the corresponding parameter setting for the asset generator. Upon detecting a user's rotating, moving, resizing and/or otherwise editing the asset in the given UI, the system 200 can automatically adjust the appearance and/or function of the asset and/or the associated parameter setting (see an example result in FIG. 6).

FIG. 6 is an illustration 600 of a UI screen for a system 200 for semantically controlling asset generators. FIG. 6 illustrates a modified version of an asset (e.g., a red mug) returned by system 200 for a user query (see, e.g., FIG. 4 and FIG. 5).

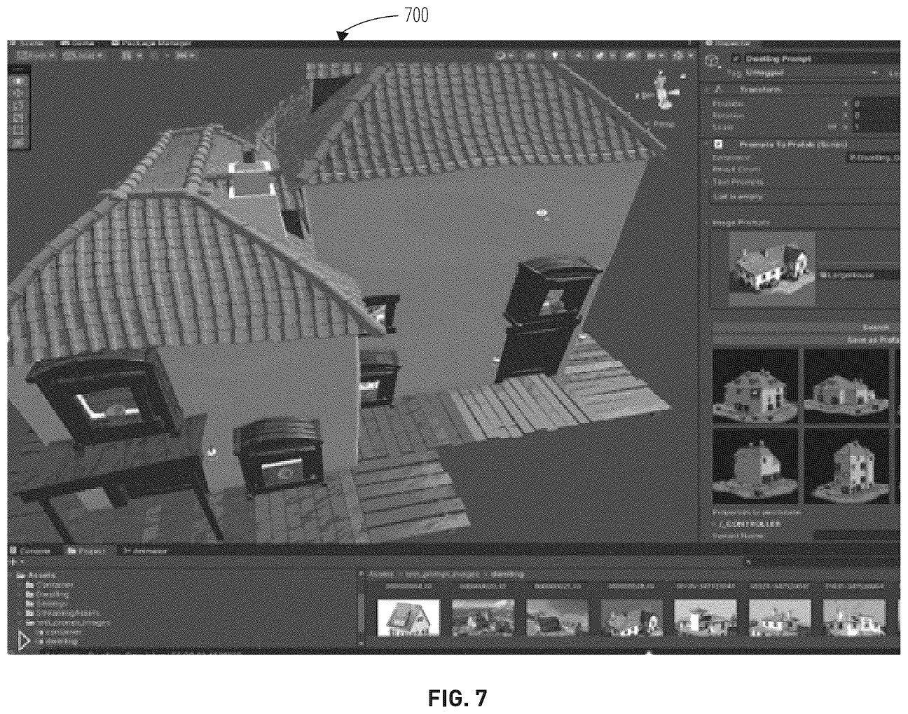

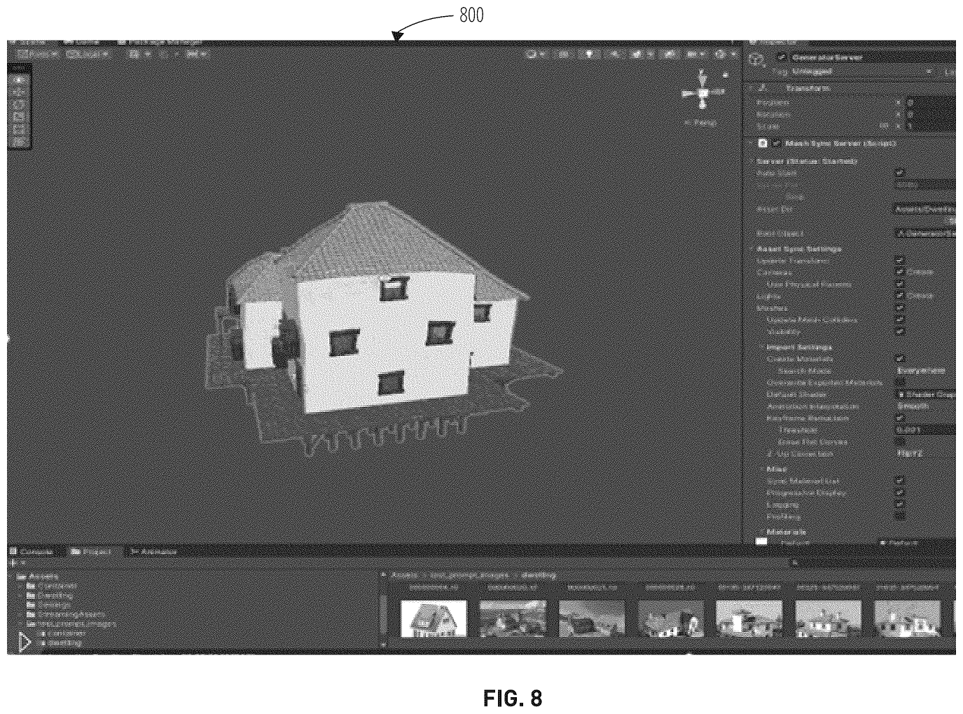

FIG. 7 is an illustration 700 of a UI screen for a system 200 for semantically controlling asset generators. The system 200 is enabled to receive NL inputs and/or image inputs. Here, system 200 receives an image prompt corresponding to a house image, while no NL descriptions or prompts are received. The system 200 constructs a query vector (as detailed in FIG. 2), and retrieves a set of K assets matching the received input (e.g., here, images of houses). As detailed in FIG. 2, system 200 retrieves K asset embeddings, each asset embedding associated with a corresponding asset, asset generator name and/or ID, as well as a set of parameter values corresponding to the parameter setting that leads the asset generator with the respective name or ID to produce the asset. Upon selecting one of the returned assets, the user can further select, examine and/or customize the asset (e.g., here, the selected house), as further seen in FIG. 8.

FIG. 8 is an illustration 800 of a UI screen for a system 200 for semantically controlling asset generators. FIG. 8 illustrates a modified version of an asset (e.g., a house) returned by system 200 for a user query (sec, e.g., FIG. 7).

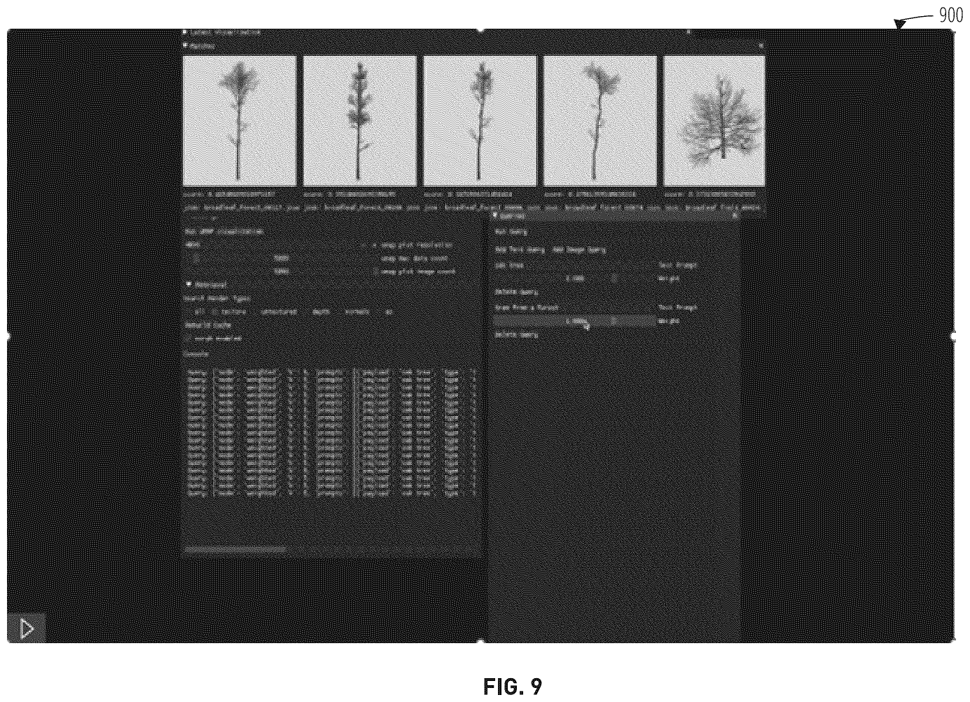

FIG. 9 is an illustration 900 of a UI screen for a system 200 for semantically controlling asset generators. System 200 receives a text query containing a NL description that specifies “tree from a forest.” System 200 constructs a query vector (as detailed in FIG. 2), and retrieves a set of K assets matching the search query. Here, the assets correspond to tree images, each retrieved asset being associated with an asset generator name and/or ID, and/or a set of parameter values corresponding to the parameter setting that leads an asset generator with the corresponding name and/or ID to produce the asset.

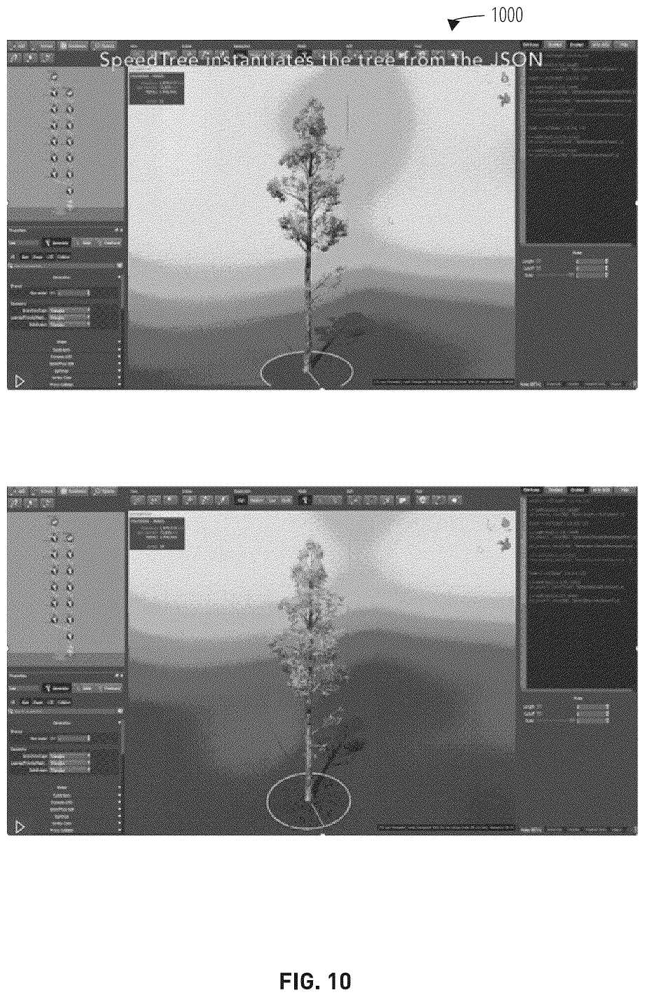

FIG. 10 is an illustration 1000 of UI screens for a system 200 for semantically controlling asset generators. After system 200 returns K assets matching a user query (e.g., the tree query in FIG. 9), the system can detect a user selection of one of the assets. System 200 displays the selected asset within the UI for further user and/or API manipulation (see, e.g., the top UI screen in FIG. 10). Upon receiving user input in the form of asset modification and/or movement requests, system 200 generates an updated version of the asset. Here, the bottom UI screen in FIG. 10 shows a modified version of the selected tree.

In some embodiments, system 200 can be used together with (or as part of) a single generative system that creates a great diversity of assets in a particular domain. For example, a SpeedTree generative system can create a great diversity of flora. In some embodiments, such a generative system can include a multi-stage generation pipeline including: a) a search for asset structure (e.g., tree structure search, involving the geometry of the trunk, limbs and branches); b) search for material assets (e.g., types of tree bark with particular appearance, etc.), c) search for asset parts and/or details (e.g., search for tree leaves). In some embodiments, system 200 can accommodate searches corresponding to one or more of the stages of the generation pipeline. The resulting assets can be assembled into one or more final results.

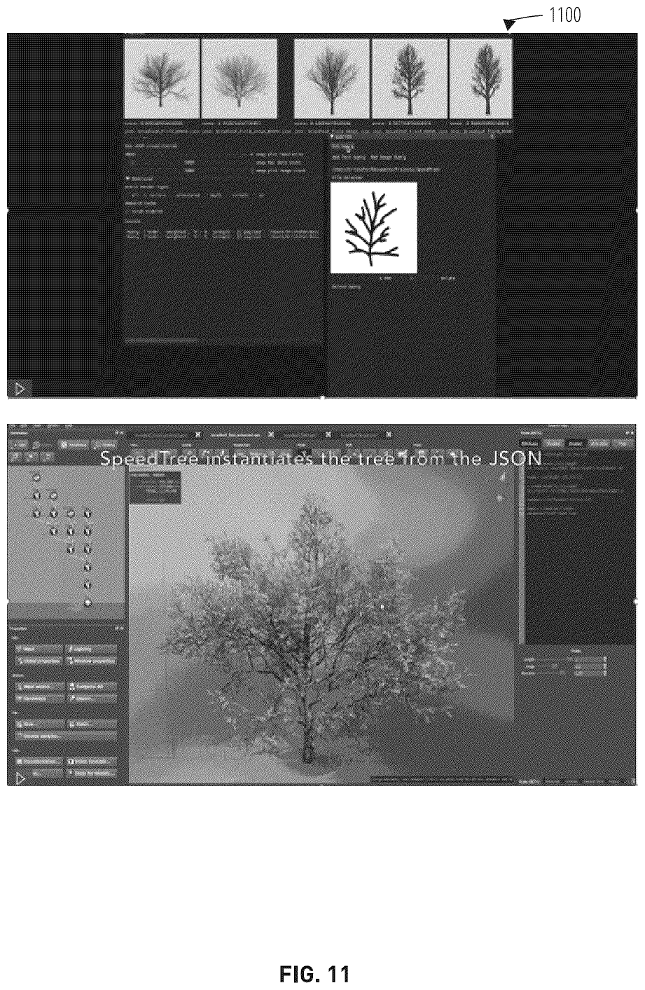

FIG. 11 is an illustration 1100 of UI screens for a system 200 for semantically controlling asset generators. In some embodiments, system 200 receives a user and/or API input in the form of a sketch (e.g., a tree sketch). In some embodiments, sketches can help highlight differences and/or structural features that are important to the user information need, whereas only using an image could obscure such structural features in favor of appearance and/or color features.

System 200 returns K assets matching the user query (sec, e.g., top UI screen in FIG. 11). Upon detecting a user selection of one of the assets, system 200 displays the selected asset within the UI for further user and/or API manipulation (see, e.g., the bottom UI screen in FIG. 11).

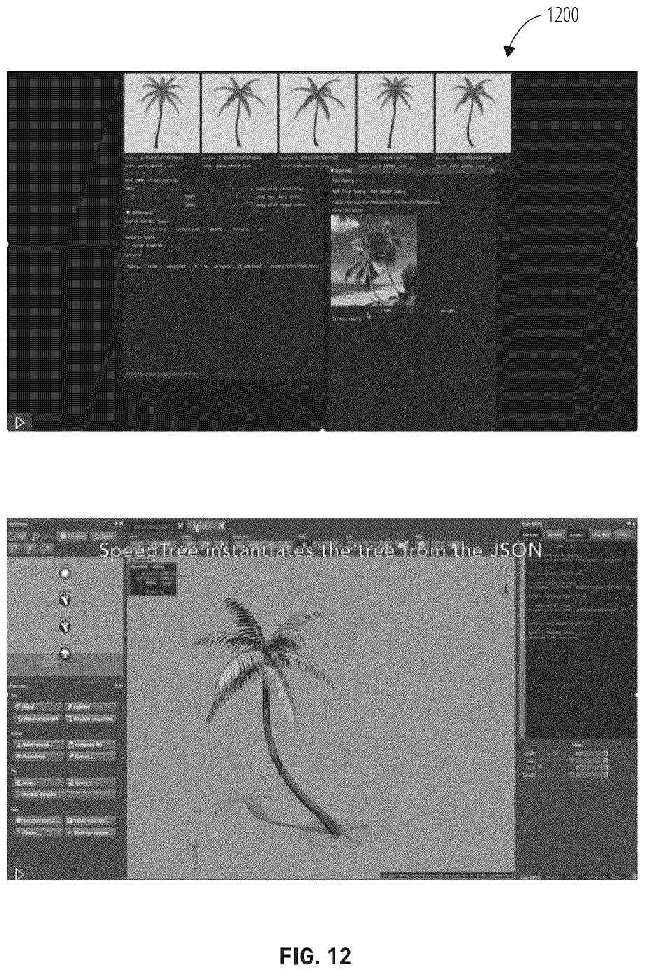

FIG. 12 is an illustration 1200 of UI screens for a system 200 for semantically controlling asset generators. In some embodiments, system 200 receives a user and/or API input in the form of an image (e.g., a tree image). System 200 returns K assets matching the user query (see, e.g., top UI screen in FIG. 12). Upon detecting a user selection of one of the assets, system 200 displays the selected asset within the UI for further user and/or API manipulation (see, e.g., the bottom UI screen in FIG. 12).

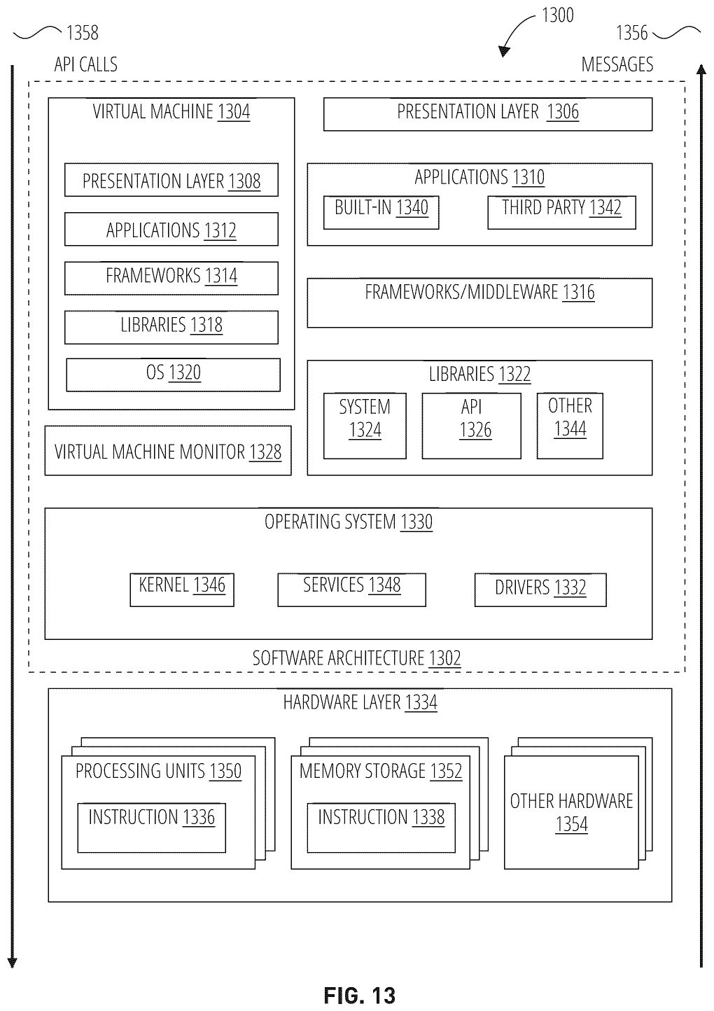

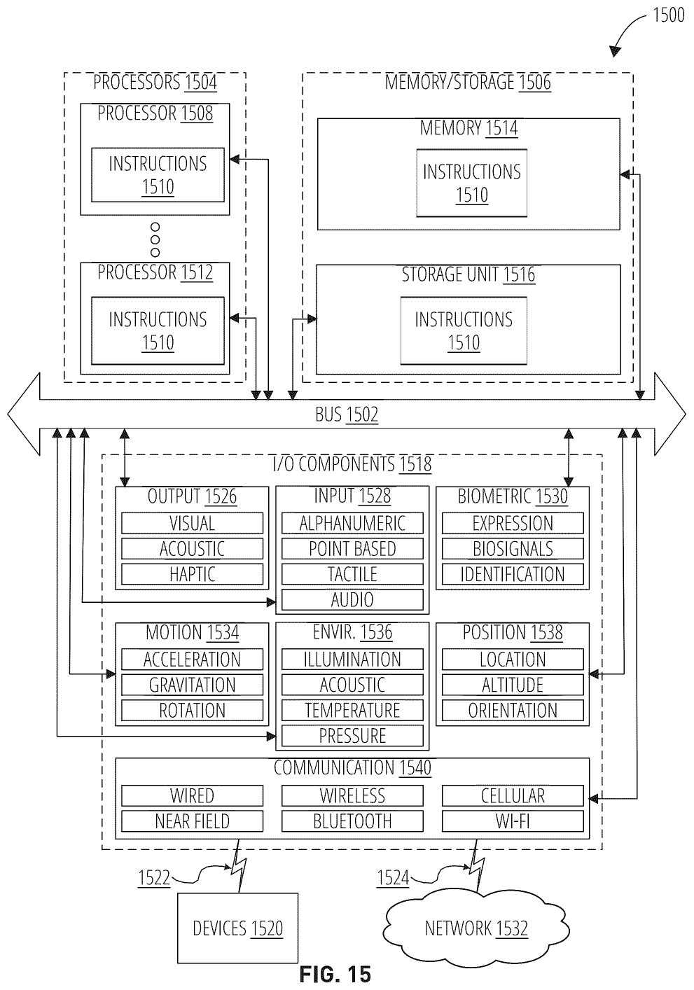

FIG. 13 is a block diagram illustrating an example of a software architecture 1302 that may be installed on a machine, according to some example embodiments. FIG. 13 is merely a non-limiting example of software architecture, and it will be appreciated that many other architectures may be implemented to facilitate the functionality described herein. The software architecture 1302 may be executing on hardware such as a machine 1500 of FIG. 15 that includes, among other things, processors 1504, memory/storage 1506, and input/output I/O components 1518. A representative hardware layer 1334 is illustrated and can represent, for example, the machine of FIG. 15. The representative hardware layer 1334 comprises one or more processing units 1350 having associated executable instructions 1336. The executable instructions 1336 represent the executable instructions of the software architecture 1302. The hardware layer 1334 also includes memory or memory storage 1352, which also have the executable instructions 1338. The hardware layer 1334 may also comprise other hardware 1354, which represents any other hardware of the hardware layer 1334 such as the other hardware illustrated as part of the machine 1500.

In the example architecture of FIG. 13, the software architecture 1302 may be conceptualized as a stack of layers, where each layer provides particular functionality. For example, the software architecture 1302 may include layers such as an operating system 1330, libraries 1318, frameworks/middleware 1316, applications 1310, and a presentation layer 1308. Operationally, the applications 1310 or other components within the layers may invoke API calls 1358 through the software stack and receive a response, returned values, and so forth (illustrated as messages 1356) in response to the API calls 1358. The layers illustrated are representative in nature, and not all software architectures have all layers. For example, some mobile or special-purpose operating systems may not provide a frameworks/middleware 1316 layer, while others may provide such a layer. Other software architectures may include additional or different layers.

The operating system 1330 may manage hardware resources and provide common services. The operating system 1330 may include, for example, a kernel 1346, services 1348, and drivers 1332. The kernel 1346 may act as an abstraction layer between the hardware and the other software layers. For example, the kernel 1346 may be responsible for memory management, processor management (e.g., scheduling), component management, networking, security settings, and so on. The services 1348 may provide other common services for the other software layers. The drivers 1332 may be responsible for controlling or interfacing with the underlying hardware. For instance, the drivers 1332 may include display drivers, camera drivers, Bluetooth® drivers, flash memory drivers, serial communication drivers (e.g., Universal Serial Bus (USB) drivers), Wi-Fi® drivers, audio drivers, power management drivers, and so forth depending on the hardware configuration.

The libraries 1318 may provide a common infrastructure that may be utilized by the applications 1310 and/or other components and/or layers. The libraries 1318 typically provide functionality that allows other software modules to perform tasks in an easier fashion than by interfacing directly with the underlying operating system 1330 functionality (e.g., kernel 1346, services 1348 or drivers 1332). The libraries 1318 may include system libraries 1318 (e.g., C standard library) that may provide functions such as memory allocation functions, string manipulation functions, mathematic functions, and the like. In addition, the libraries 1318 may include API libraries 1028 such as media libraries (e.g., libraries to support presentation and manipulation of various media formats such as MPEG4, H.264, MP3, AAC, AMR, JPG, and PNG), graphics libraries (e.g., an OpenGL framework that may be used to render 2D and 3D graphic content on a display), database libraries (e.g., SQLite that may provide various relational database functions), web libraries (e.g., WebKit that may provide web browsing functionality), and the like. The libraries 1318 may also include a wide variety of other libraries 1322 to provide many other APIs to the applications 1310 or applications 1312 and other software components/modules.

The frameworks 1314 (also sometimes referred to as middleware) may provide a higher-level common infrastructure that may be utilized by the applications 1310 or other software components/modules. For example, the frameworks 1314 may provide various graphical user interface functions, high-level resource management, high-level location services, and so forth. The frameworks 1314 may provide a broad spectrum of other APIs that may be utilized by the applications 1310 and/or other software components/modules, some of which may be specific to a particular operating system or platform.

The applications 1310 include built-in applications 1340 and/or third-party applications 1342. Examples of representative built-in applications 1340 may include, but are not limited to, a home application, a contacts application, a browser application, a book reader application, a location application, a media application, a messaging application, or a game application.

The third-party applications 1342 may include any of the built-in applications 1340 as well as a broad assortment of other applications. In a specific example, the third-party applications 1342 (e.g., an application developed using the Android™ or iOS™ software development kit (SDK) by an entity other than the vendor of the particular platform) may be mobile software running on a mobile operating system such as iOS™, Android™, or other mobile operating systems. In this example, the third-party applications 1342 may invoke the API calls 1358 provided by the mobile operating system such as the operating system 1330 to facilitate functionality described herein.

The applications 1310 may utilize built-in operating system functions, libraries (e.g., system libraries 1324, API libraries 1326, and other libraries), or frameworks/middleware 1316 to create user interfaces to interact with users of the system. Alternatively, or additionally, in some systems, interactions with a user may occur through a presentation layer, such as the presentation layer 1308. In these systems, the application/module “logic” can be separated from the aspects of the application/module that interact with the user.

Some software architectures utilize virtual machines. In the example of FIG. 13, this is illustrated by a virtual machine 1304. The virtual machine 1304 creates a software environment where applications/modules can execute as if they were executing on a hardware machine. The virtual machine 1304 is hosted by a host operating system (e.g., the operating system 1330) and typically, although not always, has a virtual machine monitor 1328, which manages the operation of the virtual machine 1304 as well as the interface with the host operating system (e.g., the operating system 1330). A software architecture executes within the virtual machine 1304, such as an operating system 1330, libraries 1318, frameworks/middleware 1316, applications 1312, or a presentation layer 1308. These layers of software architecture executing within the virtual machine 1304 can be the same as corresponding layers previously described or may be different.

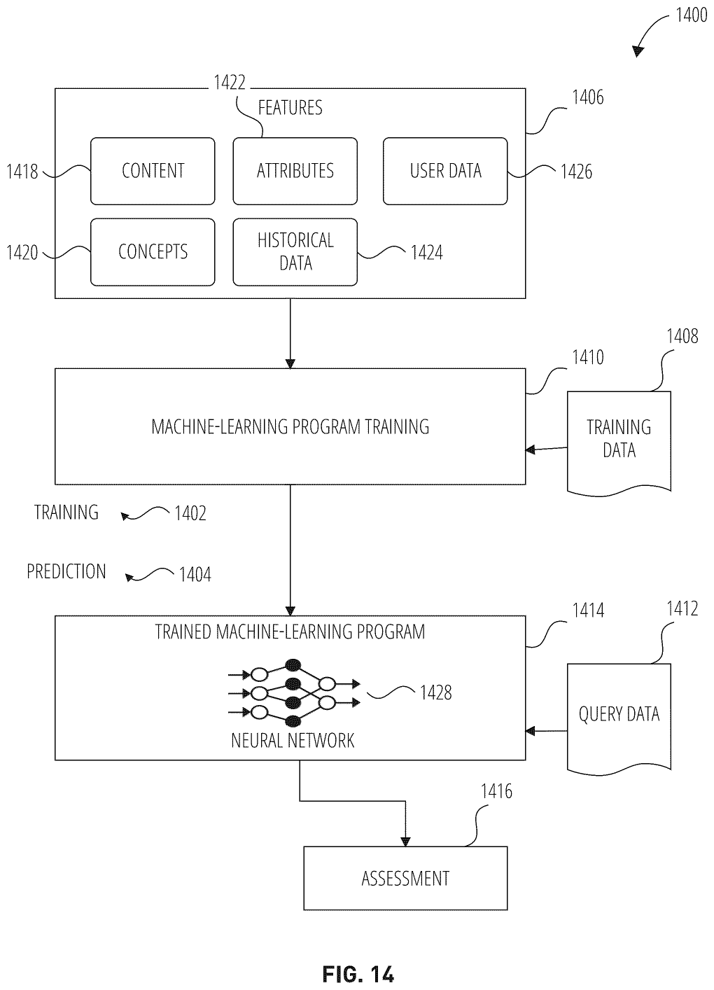

FIG. 14 is a block diagram showing a machine-learning program 1400 according to some examples. The machine-learning programs 1400, also referred to as machine-learning algorithms or tools, are used to train machine learning models, which can be used by a system for controlling asset generators, as described at least in FIG. 2.

Machine learning is a field of study that gives computers the ability to learn without being explicitly programmed. Machine learning explores the study and construction of algorithms, also referred to herein as tools, that may learn from or be trained using existing data and make predictions about or based on new data. Such machine-learning tools operate by building a model from example training data 1408 in order to make data-driven predictions or decisions expressed as outputs or assessments (e.g., assessment 1416). Although examples are presented with respect to a few machine-learning tools, the principles presented herein may be applied to other machine-learning tools.

In some examples, different machine-learning tools may be used. For example, Logistic Regression (LR), Naive-Bayes, Random Forest (RF), Gradient Boosted Decision Trees (GBDT), neural networks (NN), matrix factorization, and Support Vector Machines (SVM) tools may be used. In some examples, one or more ML paradigms may be used: binary or n-ary classification, semi-supervised learning, etc. In some examples, time-to-event (TTE) data will be used during model training. In some examples, a hierarchy or combination of models (e.g. stacking, bagging) may be used.

Two common types of problems in machine learning are classification problems and regression problems. Classification problems, also referred to as categorization problems, aim at classifying items into one of several category values (for example, is this object an apple or an orange?). Regression algorithms aim at quantifying some items (for example, by providing a value that is a real number).

The machine-learning program 1400 supports two types of phases, namely a training phase 1402 and prediction phase 1404. In a training phase 1402, supervised learning, unsupervised or reinforcement learning may be used. For example, the machine-learning program 1400 (1) receives features 1406 (e.g., as structured or labeled data in supervised learning) and/or (2) identifies features 1406 (e.g., unstructured or unlabeled data for unsupervised learning) in training data 1408. In a prediction phase 1404, the machine-learning program 1400 uses the features 1406 for analyzing query data 1412 to generate outcomes or predictions, as examples of an assessment 1416.

In the training phase 1402, feature engineering is used to identify features 1406 and may include identifying informative, discriminating, and independent features for the effective operation of the machine-learning program 1400 in pattern recognition, classification, and regression. In some examples, the training data 1408 includes labeled data, which is known data for pre-identified features 1406 and one or more outcomes. Each of the features 1406 may be a variable or attribute, such as individual measurable property of a process, article, system, or phenomenon represented by a data set (e.g., the training data 1408). Features 1406 may also be of different types, such as numeric features, strings, and graphs, and may include one or more of content 1418, concepts 1420, attributes 1422, historical data 1424 and/or user data 1426, merely for example.

In training phases 1402, the machine-learning program 1400 uses the training data 1408 to find correlations among the features 1406 that affect a predicted outcome or assessment 1416.

With the training data 1408 and the identified features 1406, the machine-learning program 1400 is trained during the training phase 1402 at machine-learning program training 1410. The machine-learning program 1400 appraises values of the features 1406 as they correlate to the training data 1408. The result of the training is the trained machine-learning program 1414 (e.g., a trained or learned model).

Further, the training phases 1402 may involve machine learning, in which the training data 1408 is structured (e.g., labeled during preprocessing operations), and the trained machine-learning program 1414 implements a relatively simple neural network 1428 (or one of other machine learning models, as described herein) capable of performing, for example, classification and clustering operations. In other examples, the training phase 1402 may involve deep learning, in which the training data 1408 is unstructured, and the trained machine-learning program 1414 implements a deep neural network 1428 that is able to perform both feature extraction and classification/clustering operations.

A neural network 1428 generated during the training phase 1402, and implemented within the trained machine-learning program 1414, may include a hierarchical (e.g., layered) organization of neurons. For example, neurons (or nodes) may be arranged hierarchically into a number of layers, including an input layer, an output layer, and multiple hidden layers. The layers within the neural network 1428 can have one or many neurons, and the neurons operationally compute a small function (e.g., activation function). For example, if an activation function generates a result that transgresses a particular threshold, an output may be communicated from that neuron (e.g., transmitting neuron) to a connected neuron (e.g., receiving neuron) in successive layers. Connections between neurons also have associated weights, which define the influence of the input from a transmitting neuron to a receiving neuron.

In some examples, the neural network 1428 may also be one of a number of different types of neural networks, including a single-layer feed-forward network, an Artificial Neural Network (ANN), a Recurrent Neural Network (RNN), a symmetrically connected neural network, and unsupervised pre-trained network, a Convolutional Neural Network (CNN), or a Recursive Neural Network (RNN), merely for example.

During prediction phases 1404 the trained machine-learning program 1414 is used to perform an assessment. Query data 1412 is provided as an input to the trained machine-learning program 1414, and the trained machine-learning program 1414 generates the assessment 1416 as output, responsive to receipt of the query data 1412.

In some examples, the trained machine-learning program 1414 may be a generative AI model. Generative AI is a term that may refer to any type of artificial intelligence that can create new content from training data 1408. For example, generative AI can produce text, images, video, audio, code, or synthetic data similar to the original data but not identical.

Some of the techniques that may be used in generative AI are:
Convolutional Neural Networks (CNNs): CNNs may be used for image recognition and computer vision tasks. CNNs may, for example, be designed to extract features from images by using filters or kernels that scan the input image and highlight important patterns.
Recurrent Neural Networks (RNNs): RNNs may be used for processing sequential data, such as speech, text, and time series data, for example. RNNs employ feedback loops that allow them to capture temporal dependencies and remember past inputs.
Generative adversarial networks (GANs): GNNs may include two neural networks: a generator and a discriminator. The generator network attempts to create realistic content that can “fool” the discriminator network, while the discriminator network attempts to distinguish between real and fake content. The generator and discriminator networks compete with each other and improve over time.
Variational autoencoders (VAEs): VAEs may encode input data into a latent space (e.g., a compressed representation) and then decode it back into output data. The latent space can be manipulated to generate new variations of the output data. VAEs may use self-attention mechanisms to process input data, allowing them to handle long text sequences and capture complex dependencies.
Transformer models: Transformer models may use attention mechanisms to learn the relationships between different parts of input data (such as words or pixels) and generate output data based on these relationships. Transformer models can handle sequential data, such as text or speech, as well as non-sequential data, such as images, code and so forth. In generative AI examples, the output prediction/inference data include predictions, translations, summaries or media content.

### Example: Storing a Trained Model With ONNX File Format

A trained neural network model (e.g., a trained machine learning program 1414 using a neural network 1428) may be stored in a computational graph format, according to some examples. An example computational graph format is the Open Neural Network Exchange (ONNX) file format, an open, flexible standard for storing models which allows reusing models across deep learning platforms/tools, and deploying models in the cloud (e.g., via ONNX runtime).

In some examples, the ONNX file format corresponds to a computational graph in the form of a directed graph whose nodes (or layers) correspond to operators and whose edges correspond to tensors. In some examples, the operators (or operations) take the incoming tensors as inputs, and output result tensors, which are in turn used as inputs by their children.

In some examples, trained neural network models (e.g., examples of trained machine learning programs 1414) developed and trained using frameworks such as TensorFlow, Keras, PyTorch, and so on can be automatically exported to the ONNX format using framework-specific export functions. For instance, PyTorch allows the use of a torch.export (trainedModel, outputFile ( . . . )) function to export a trained model ready to be run to a file using the ONNX file format. Similarly, TensorFlow and Keras allow the use of the tf2onnx library for converting trained models to the ONNX file format, while Keras also allows the use of keras2onnx for the same purpose.

In example embodiments, one or more artificial intelligence agents, such as one or more machine-learned algorithms or models and/or a neural network of one or more machine-learned algorithms or models may be trained iteratively (e.g., in a plurality of stages) using a plurality of sets of input data. For example, a first set of input data may be used to train one or more of the artificial agents. Then, the first set of input data may be transformed into a second set of input data for retraining the one or more artificial intelligence agents. The continuously updated and retrained artificial intelligence agents may then be applied to subsequent novel input data to generate one or more of the outputs described herein.

FIG. 15 is a block diagram illustrating components of a machine 1500, according to some example embodiments, able to read instructions from a machine-readable medium (e.g., a machine-readable storage medium) and perform any one or more of the methodologies discussed herein. Specifically, FIG. 15 shows a diagrammatic representation of the machine 1500 in the example form of a computer system, within which instructions 1510 (e.g., software, a program, an application, an applet, an app, or other executable code) for causing the machine 1500 to perform any one or more of the methodologies discussed herein may be executed. As such, the instructions 1510 may be used to implement modules or components described herein. The instructions 1510 transform the general, non-programmed machine 1500 into a particular machine 1500 to carry out the described and illustrated functions in the manner described. In alternative embodiments, the machine 1500 operates as a standalone device or may be coupled (e.g., networked) to other machines. In a networked deployment, the machine 1500 may operate in the capacity of a server machine or a client machine in a server-client network environment, or as a peer machine in a peer-to-peer (or distributed) network environment. The machine 1500 may comprise, but not be limited to, a server computer, a client computer, a personal computer (PC), a tablet computer, a laptop computer, a netbook, a personal digital assistant (PDA), an entertainment media system, a cellular telephone, a smart phone, a mobile device, a wearable device (e.g., a smart watch), other smart devices, a web appliance, a network router, a network switch, a network bridge, or any machine capable of executing the instructions 1510, sequentially or otherwise, that specify actions to be taken by machine 1500. Further, while only a single machine 1500 is illustrated, the term “machine” shall also be taken to include a collection of machines that individually or jointly execute the instructions 1510 to perform any one or more of the methodologies discussed herein.

The machine 1500 may include processors 1504, memory/storage 1506, and I/O components 1518, which may be configured to communicate with each other such as via a bus 1502. The memory/storage 1506 may include a memory 1514, such as a main memory, or other memory storage, and a storage unit 1516, both accessible to the processors 1504 such as via the bus 1502. The storage unit 1516 and memory 1514 store the instructions 1510 embodying any one or more of the methodologies or functions described herein. The instructions 1510 may also reside, completely or partially, within the memory 1514 within the storage unit 1516, within at least one of the processors 1504 (e.g., within the processor's cache memory), or any suitable combination thereof, during execution thereof by the machine 1500. Accordingly, the memory 1514 the storage unit 1516, and the memory of processors 1504 are examples of machine-readable media.

The I/O components 1518 may include a wide variety of components to receive input, provide output, produce output, transmit information, exchange information, capture measurements, and so on. The specific I/O components 1518 that are included in a particular machine 1500 will depend on the type of machine. For example, portable machines such as mobile phones will likely include a touch input device or other such input mechanisms, while a headless server machine will likely not include such a touch input device. It will be appreciated that the I/O components 1518 may include many other components that are not shown in FIG. 15. The I/O components 1518 are grouped according to functionality merely for simplifying the following discussion and the grouping is in no way limiting. In various example embodiments, the I/O components 1518 may include output components 1526 and input components 1528. The output components 1526 may include visual components (e.g., a display such as a plasma display image (PDP), a light emitting diode (LED) display, a liquid crystal display (LCD), a projector, or a cathode ray tube (CRT)), acoustic components (e.g., speakers), haptic components (e.g., a vibratory motor, resistance mechanisms), other signal generators, and so forth. The input components 1528 may include alphanumeric input components (e.g., a keyboard, a touch screen configured to receive alphanumeric input, a photo-optical keyboard, or other alphanumeric input components), point based input components (e.g., a mouse, a touchpad, a trackball, a joystick, a motion sensor, or other pointing instrument), tactile input components (e.g., a physical button, a touch screen that provides location and/or force of touches or touch gestures, or other tactile input components), audio input components (e.g., a microphone), and the like.

In further example embodiments, the I/O components 1518 may include biometric components 1530, motion components 1534, environmental environment components 1536, or position components 1538 among a wide array of other components. For example, the biometric components 830 may include components to detect expressions (e.g., hand expressions, facial expressions, vocal expressions, body gestures, or eye tracking), measure biosignals (e.g., blood pressure, heart rate, body temperature, perspiration, or brain waves), identify a person (e.g., voice identification, retinal identification, facial identification, fingerprint identification, or electroencephalogram based identification), and the like. The motion components 1534 may include acceleration sensor components (e.g., accelerometer), gravitation sensor components, rotation sensor components (e.g., gyroscope), and so forth. The environment components 1536 may include, for example, illumination sensor components (e.g., photometer), temperature sensor components (e.g., one or more thermometer that detect ambient temperature), humidity sensor components, pressure sensor components (e.g., barometer), acoustic sensor components (e.g., one or more microphones that detect background noise), proximity sensor components (e.g., infrared sensors that detect nearby objects), gas sensors (e.g., gas detection sensors to detection concentrations of hazardous gases for safety or to measure pollutants in the atmosphere), or other components that may provide indications, measurements, or signals corresponding to a surrounding physical environment. The position components 1538 may include location sensor components (e.g., a Global Position system (GPS) receiver component), altitude sensor components (e.g., altimeters or barometers that detect air pressure from which altitude may be derived), orientation sensor components (e.g., magnetometers), and the like.

Communication may be implemented using a wide variety of technologies. The I/O components 1518 may include communication components 1540 operable to couple the machine 1500 to a network 1532 or devices 1520 via coupling 1522 and coupling 1524 respectively. For example, the communication components 1540 may include a network interface component or other suitable device to interface with the network 1532. In further examples, communication components 1540 may include wired communication components, wireless communication components, cellular communication components, Near Field Communication (NFC) components, Bluetooth® components (e.g., Bluetooth® Low Energy), Wi-Fi® components, and other communication components to provide communication via other modalities. The devices 1520 may be another machine or any of a wide variety of peripheral devices (e.g., a peripheral device coupled via a Universal Serial Bus (USB)).

Moreover, the communication components 1540 may detect identifiers or include components operable to detect identifiers. For example, the communication components 1540 may include Radio Frequency Identification (RFID) tag reader components, NFC smart tag detection components, optical reader components (e.g., an optical sensor to detect one-dimensional bar codes such as Universal Product Code (UPC) bar code, multi-dimensional bar codes such as Quick Response (QR) code, Aztec code, Data Matrix, Dataglyph, MaxiCode, PDF417, Ultra Code, UCC RSS-2D bar code, and other optical codes), or acoustic detection components (e.g., microphones to identify tagged audio signals). In addition, a variety of information may be derived via the communication components 1540, such as, location via Internet Protocol (IP) geo-location, location via Wi-Fi® signal triangulation, location via detecting a NFC beacon signal that may indicate a particular location, and so forth.

### EXAMPLES

Example 1 is a non-transitory computer-readable storage medium storing instructions that, when executed by at least one processor, cause the at least one processor to perform operations comprising: determining sets of parameter values for parameters of one or more asset generators; generating assets using the one or more asset generators and the determined sets of parameter values; generating, using one or more encoding models, asset embeddings for the generated assets; and storing the asset embeddings and one or more of the generated assets or asset generator information associated with the one or more asset generators.

In Example 2, the subject matter of Example 1 includes, the operations further comprising: receiving a set of query inputs; computing a query embedding using the set of query inputs; and retrieving a set of asset embeddings matching the query embedding, each asset embedding in the set of asset embeddings being associated with a corresponding asset and corresponding asset generator information.

In Example 3, the subject matter of Example 2 includes, wherein the corresponding asset generator information for an asset embedding further comprises an asset generator ID and a set of parameter values, the asset associated with the asset embedding being enabled to be generated using an asset generator with the asset generator ID and the set of parameter values.

In Example 4, the subject matter of Example 3 includes, the operations further comprising: displaying, via a user interface (UI), the retrieved assets associated with the set of retrieved asset embeddings matching the query embedding; and upon receiving, via the UI, a user selection of an asset associated with an asset embedding of the set of retrieved asset embeddings: retrieving the asset generator ID and corresponding set of parameter values associated with the asset embedding; and upon detecting a user editing operation associated with the asset: updating the set of parameter values based on the user editing operation; and storing the updated set of parameter values and the edited asset.

In Example 5, the subject matter of Example 4 includes, the operations further comprising: upon retrieving the asset generator ID and corresponding set of parameter values associated with the asset embedding: displaying, in the UI, the asset and the corresponding set of parameter values; and upon receiving one or more user updates to the corresponding set of parameter values: storing the updated set of parameter values; generating, using the asset generator ID and the updated set of parameter values, an updated asset; and storing the updated asset associated with one or more of the asset generator ID and the updated set of parameter values.

In Example 6, the subject matter of Examples 2-5 includes, wherein the query inputs comprise one or more of at least an image input or a natural language (NL) input.

In Example 7, the subject matter of Examples 2-6 includes, receiving one or more weights, each weight associated with a query input of the set of query inputs; and wherein computing a query embedding using the set of query inputs further comprises: generating query input embeddings based on the set of query inputs and one or more encoding models; and generating the query embedding based on the query input embeddings, the one or more weights, and a combination function.

In Example 8, the subject matter of Examples 1-7 includes, wherein generating asset embeddings for the generated assets further comprises: generating an asset representation for each asset using a representation model; and generating, using the one or more encoding models, an asset embedding corresponding to the asset representation for each asset.

In Example 9, the subject matter of Example 8 includes, wherein the representation model is one of at least a shaded rendering model, a stylized rendering model, or a text captioning model.

In Example 10, the subject matter of Examples 1-9 includes, wherein the one or more encoding models are joint image and text embedding models.

Example 11 is a method comprising: determining, at a computing device, sets of parameter values for parameters of one or more asset generators; generating assets using the one or more asset generators and the determined sets of parameter values; generating, using one or more encoding models, asset embeddings for the generated assets; and storing the asset embeddings and one or more of the generated assets or asset generator information associated with the one or more asset generators.

In Example 12, the subject matter of Example 11 includes, receiving a set of query inputs; computing a query embedding using the set of query inputs; and retrieving a set of asset embeddings matching the query embedding, each asset embedding in the set of asset embeddings being associated with a corresponding asset and corresponding asset generator information.

In Example 13, the subject matter of Example 12 includes, wherein the corresponding asset generator information for an asset embedding further comprises an asset generator ID and a set of parameter values, the asset associated with the asset embedding being enabled to be generated using an asset generator with the asset generator ID and the set of parameter values.

In Example 14, the subject matter of Example 13 includes, displaying, via a user interface (UI), the retrieved assets associated with the set of retrieved asset embeddings matching the query embedding; and upon receiving, via the UI, a user selection of an asset associated with an asset embedding of the set of retrieved asset embeddings: retrieving the asset generator ID and corresponding set of parameter values associated with the asset embedding; and upon detecting a user editing operation associated with the asset: updating the set of parameter values based on the user editing operation; and storing the updated set of parameter values and the edited asset.

In Example 15, the subject matter of Example 14 includes, upon retrieving the asset generator ID and corresponding set of parameter values associated with the asset embedding: displaying, in the UI, the asset and the corresponding set of parameter values; and upon receiving one or more user updates to the corresponding set of parameter values: storing the updated set of parameter values; generating, using the asset generator ID and the updated set of parameter values, an updated asset; and storing the updated asset associated with one or more of the asset generator ID and the updated set of parameter values.

In Example 16, the subject matter of Examples 12-15 includes, wherein the query inputs comprise one or more of at least an image input or a natural language (NL) input.

In Example 17, the subject matter of Examples 12-16 includes, receiving one or more weights, each weight associated with a query input of the set of query inputs; and wherein computing a query embedding using the set of query inputs further comprises: generating query input embeddings based on the set of query inputs and one or more encoding models; and generating the query embedding based on the query input embeddings, the one or more weights, and a combination function.

In Example 18, the subject matter of Examples 11-17 includes, wherein generating asset embeddings for the generated assets further comprises: generating an asset representation for each asset using a representation model; and generating, using the one or more encoding models, an asset embedding corresponding to the asset representation for each asset.

In Example 19, the subject matter of Example 18 includes, wherein the representation model is one of at least a shaded rendering model, a stylized rendering model, or a text captioning model.

Example 20 is a system comprising: one or more computer processors; one or more computer memories; and a set of instructions stored in the one or more computer memories, the set of instructions configuring the one or more computer processors to perform operations, the operations comprising: determining sets of parameter values for parameters of one or more asset generators; generating assets using the one or more asset generators and the determined sets of parameter values; generating, using one or more encoding models, asset embeddings for the generated assets; and storing the asset embeddings and one or more of the generated assets or asset generator information associated with the one or more asset generators.

Example 21 is a non-transitory computer-readable storage medium storing instructions that, when executed by at least one processor, cause the at least one processor to perform operations comprising: determining parametrization settings for one or more asset generators, the one or more asset generators being associated with a plurality of parametrization schemes; generating assets using the one or more asset generators and the parametrization settings; generating, using an encoding model, asset embeddings corresponding to the assets, the asset embeddings using a common embedding space; storing the asset embeddings and asset information associated with the one or more asset generators; and upon receiving query inputs, generating a query embedding in the common embedding space based on the query inputs; and retrieving a set of asset embeddings relevant to the query embedding, each asset embedding in the set of asset embeddings being associated with corresponding asset information for a respective asset generator of the one or more asset generators.

Example 22 is at least one machine-readable medium including instructions that, when executed by processing circuitry, cause the processing circuitry to perform operations to implement of any of Examples 1-21.

Example 23 is an apparatus comprising means to implement any of Examples 1-21.

Example 24 is a system to implement any of Examples 1-21.

Example 25 is a method to implement any of Examples 1-21.

### GLOSSARY

“CARRIER SIGNAL” in this context refers to any intangible medium that is capable of storing, encoding, or carrying instructions for execution by the machine, and includes digital or analog communications signals or other intangible medium to facilitate communication of such instructions. Instructions may be transmitted or received over the network using a transmission medium via a network interface device and using any one of a number of well-known transfer protocols.
“CLIENT DEVICE” in this context refers to any machine that interfaces to a communications network to obtain resources from one or more server systems or other client devices. A client device may be, but is not limited to, a mobile phone, desktop computer, laptop, portable digital assistants (PDAs), smart phones, tablets, ultra books, netbooks, laptops, multi-processor systems, microprocessor-based or programmable consumer electronics, game consoles, set-top boxes, or any other communication device that a user may use to access a network.
“COMMUNICATIONS NETWORK” in this context refers to one or more portions of a network that may be an ad hoc network, an intranet, an extranet, a virtual private network (VPN), a local area network (LAN), a wireless LAN (WLAN), a wide area network (WAN), a wireless WAN (WWAN), a metropolitan area network (MAN), the Internet, a portion of the Internet, a portion of the Public Switched Telephone Network (PSTN), a plain old telephone service (POTS) network, a cellular telephone network, a wireless network, a Wi-Fi® network, another type of network, or a combination of two or more such networks. For example, a network or a portion of a network may include a wireless or cellular network and the coupling may be a Code Division Multiple Access (CDMA) connection, a Global System for Mobile communications (GSM) connection, or other type of cellular or wireless coupling. In this example, the coupling may implement any of a variety of types of data transfer technology, such as Single Carrier Radio Transmission Technology (1xRTT), Evolution-Data Optimized (EVDO) technology, General Packet Radio Service (GPRS) technology, Enhanced Data rates for GSM Evolution (EDGE) technology, third Generation Partnership Project (3GPP) including 3G, fourth generation wireless (4G) networks, Universal Mobile Telecommunications System (UMTS), High Speed Packet Access (HSPA), Worldwide Interoperability for Microwave Access (WiMAX), Long Term Evolution (LTE) standard, others defined by various standard setting organizations, other long range protocols, or other data transfer technology.
“MACHINE-READABLE MEDIUM” in this context refers to a component, device or other tangible media able to store instructions and data temporarily or permanently and may include, but is not be limited to, random-access memory (RAM), read-only memory (ROM), buffer memory, flash memory, optical media, magnetic media, cache memory, other types of storage (e.g., Erasable Programmable Read-Only Memory (EEPROM)) and/or any suitable combination thereof. The term “machine-readable medium” should be taken to include a single medium or multiple media (e.g., a centralized or distributed database, or associated caches and servers) able to store instructions. The term “machine-readable medium” shall also be taken to include any medium, or combination of multiple media, that is capable of storing instructions (e.g., code) for execution by a machine, such that the instructions, when executed by one or more processors of the machine, cause the machine to perform any one or more of the methodologies described herein. Accordingly, a “machine-readable medium” refers to a single storage apparatus or device, as well as “cloud-based” storage systems or storage networks that include multiple storage apparatus or devices. The term “machine-readable medium” excludes signals per sc.
“COMPONENT” in this context refers to a device, physical entity or logic having boundaries defined by function or subroutine calls, branch points, application program interfaces (APIs), or other technologies that provide for the partitioning or modularization of particular processing or control functions. Components may be combined via their interfaces with other components to carry out a machine process. A component may be a packaged functional hardware unit designed for use with other components and a part of a program that usually performs a particular function of related functions. Components may constitute either software components (e.g., code embodied on a machine-readable medium) or hardware components. A “hardware component” is a tangible unit capable of performing certain operations and may be configured or arranged in a certain physical manner. In various example embodiments, one or more computer systems (e.g., a standalone computer system, a client computer system, or a server computer system) or one or more hardware components of a computer system (e.g., a processor or a group of processors) may be configured by software (e.g., an application or application portion) as a hardware component that operates to perform certain operations as described herein. A hardware component may also be implemented mechanically, electronically, or any suitable combination thereof. For example, a hardware component may include dedicated circuitry or logic that is permanently configured to perform certain operations. A hardware component may be a special-purpose processor, such as a Field-Programmable Gate Array (FPGA) or an Application Specific Integrated Circuit (ASIC). A hardware component may also include programmable logic or circuitry that is temporarily configured by software to perform certain operations. For example, a hardware component may include software executed by a general-purpose processor or other programmable processor. Once configured by such software, hardware components become specific machines (or specific components of a machine) uniquely tailored to perform the configured functions and are no longer general-purpose processors. It will be appreciated that the decision to implement a hardware component mechanically, in dedicated and permanently configured circuitry, or in temporarily configured circuitry (e.g., configured by software) may be driven by cost and time considerations. Accordingly, the phrase “hardware component” (or “hardware-implemented component”) should be understood to encompass a tangible entity, be that an entity that is physically constructed, permanently configured (e.g., hardwired), or temporarily configured (e.g., programmed) to operate in a certain manner or to perform certain operations described herein. Considering embodiments in which hardware components are temporarily configured (e.g., programmed), each of the hardware components need not be configured or instantiated at any one instance in time. For example, where a hardware component comprises a general-purpose processor configured by software to become a special-purpose processor, the general-purpose processor may be configured as respectively different special-purpose processors (e.g., comprising different hardware components) at different times. Software accordingly configures a particular processor or processors, for example, to constitute a particular hardware component at one instance of time and to constitute a different hardware component at a different instance of time. Hardware components can provide information to, and receive information from, other hardware components. Accordingly, the described hardware components may be regarded as being communicatively coupled. Where multiple hardware components exist contemporaneously, communications may be achieved through signal transmission (e.g., over appropriate circuits and buses) between or among two or more of the hardware components. In embodiments in which multiple hardware components are configured or instantiated at different times, communications between such hardware components may be achieved, for example, through the storage and retrieval of information in memory structures to which the multiple hardware components have access. For example, one hardware component may perform an operation and store the output of that operation in a memory device to which it is communicatively coupled. A further hardware component may then, at a later time, access the memory device to retrieve and process the stored output. Hardware components may also initiate communications with input or output devices, and can operate on a resource (e.g., a collection of information). The various operations of example methods described herein may be performed, at least partially, by one or more processors that are temporarily configured (e.g., by software) or permanently configured to perform the relevant operations. Whether temporarily or permanently configured, such processors may constitute processor-implemented components that operate to perform one or more operations or functions described herein. As used herein, “processor-implemented component” refers to a hardware component implemented using one or more processors. Similarly, the methods described herein may be at least partially processor-implemented, with a particular processor or processors being an example of hardware. For example, at least some of the operations of a method may be performed by one or more processors or processor-implemented components. Moreover, the one or more processors may also operate to support performance of the relevant operations in a “cloud computing” environment or as a “software as a service” (SaaS). For example, at least some of the operations may be performed by a group of computers (as examples of machines including processors), with these operations being accessible via a network (e.g., the Internet) and via one or more appropriate interfaces (e.g., an Application Program Interface (API)). The performance of certain of the operations may be distributed among the processors, not only residing within a single machine, but deployed across a number of machines. In some example embodiments, the processors or processor-implemented components may be located in a single geographic location (e.g., within a home environment, an office environment, or a server farm). In other example embodiments, the processors or processor-implemented components may be distributed across a number of geographic locations.
“PROCESSOR” in this context refers to any circuit or virtual circuit (a physical circuit emulated by logic executing on an actual processor) that manipulates data values according to control signals (e.g., “commands”, “op codes”, “machine code”, etc.) and which produces corresponding output signals that are applied to operate a machine. A processor may, for example, be a Central Processing Unit (CPU), a Reduced Instruction Set Computing (RISC) processor, a Complex Instruction Set Computing (CISC) processor, a Graphics Processing Unit (GPU), a Digital Signal Processor (DSP), an Application Specific Integrated Circuit (ASIC), a Radio-Frequency Integrated Circuit (RFIC) or any combination thereof. A processor may further be a multi-core processor having two or more independent processors (sometimes referred to as “cores”) that may execute instructions contemporaneously.
“TIMESTAMP” in this context refers to a sequence of characters or encoded information identifying when a certain event occurred, for example giving date and time of day, sometimes accurate to a small fraction of a second.
“TIME DELAYED NEURAL NETWORK (TDNN)” in this context, a TDNN is an artificial neural network architecture whose primary purpose is to work on sequential data. An example would be converting continuous audio into a stream of classified phoneme labels for speech recognition.
“BI-DIRECTIONAL LONG-SHORT TERM MEMORY (BLSTM)” in this context refers to a recurrent neural network (RNN) architecture that remembers values over arbitrary intervals. Stored values are not modified as learning proceeds. RNNs allow forward and backward connections between neurons. BLSTM are well-suited for the classification, processing, and prediction of time series, given time lags of unknown size and duration between events.
“SHADER” in this context refers to a program that runs on a GPU, a CPU, a TPU, a NPU and so forth. In the following, a non-exclusive listing of types of shaders is offered. Shader programs may be part of a graphics pipeline. Shaders may also be compute shaders or programs that perform calculations on a CPU or a GPU (e.g., outside of a graphics pipeline, etc.). Shaders may perform calculations that determine pixel properties (e.g., pixel colors). Shaders may refer to ray tracing shaders that perform calculations related to ray tracing. A shader object may (e.g., an instance of a shader class) may be a wrapper for shader programs and other information. A shader asset may refer to a shader file (or a “shader” extension file), which may define a shader object.
“ASSET” in this context refers to an object, object template (e.g., Unity prefab), multimedia object, and/or other artifacts (e.g., digital artifacts, etc.). In the following, a non-exclusive listing of types of assets is offered. Assets can be 2D or 3D assets. They can be used to create immersive and/or interactive experiences across various platforms, including games, simulations, and virtual reality applications. Examples of assets can include game objects, such as characters, enemies, or NPCs (non-player characters) with complex animations and behaviors. Assets can include environmental elements such as terrain, trees, plants, and/or partial or whole environmental scenes. For example, a rendering engine can render detailed landscapes in the context of immersive worlds. Assets can include architectural models, such as buildings, interiors, and/or urban landscapes used in architectural visualizations or urban planning simulations. Such models can be imported into a game engine or other code base for real-time walkthroughs or simulations. Assets can include vehicles or props, such as cars, planes, and/or other vehicles, furniture, tools, weapons and so forth. Assets can have moving parts and/or require specific interactions, representing dynamic objects. Assets can include UI elements such as buttons, menus, or HUDs (Heads-Up Displays). In some examples, assets can include stylized UI assets that match, for example, the artistic style of other 3D assets such as game assets or immersive world assets. Assets can include particle effects or shaders. For example, assets can include special effects like fire, smoke, explosions and/or other sound effects, or custom shaders for custom visual appearances. Assets can include animation clips and/or rigs, such as animation sequences for character movement, facial expressions, and/or other animated actions, and/or skeletal rigs. Such assets can be used to create lifelike animations. Assets can include any combination of modalities, such as text data, image data, video data, audio data, signal data, and so forth. Assets can include augmented reality (AR) and/or virtual reality (VR) components.

Throughout this specification, plural instances may implement resources, components, operations, or structures described as a single instance. Although individual operations of one or more methods are illustrated and described as separate operations, one or more of the individual operations may be performed concurrently, and nothing requires that the operations be performed in the order illustrated. Structures and functionality presented as separate components in example configurations may be implemented as a combined structure or component. Similarly, structures and functionality presented as a single component may be implemented as separate components.

As used herein, the term “or” may be construed in either an inclusive or exclusive sense. The terms “a” or “an” should be read as meaning “at least one,” “one or more,” or the like. The presence of broadening words and phrases such as “one or more,” “at least,” “but not limited to,” or other like phrases in some instances shall not be read to mean that the narrower case is intended or required in instances where such broadening phrases may be absent. Additionally, boundaries between various resources, operations, modules, engines, and data stores are somewhat arbitrary, and particular operations are illustrated in a context of specific illustrative configurations. Other allocations of functionality are envisioned and may fall within a scope of various embodiments of the present disclosure. The specification and drawings are, accordingly, to be regarded in an illustrative rather than a restrictive sense.

It will be understood that changes and modifications may be made to the disclosed embodiments without departing from the scope of the present disclosure. These and other changes or modifications are intended to be included within the scope of the present disclosure.

What is claimed is:

1. A non-transitory computer-readable storage medium storing instructions that, when executed by at least one processor, cause the at least one processor to perform operations comprising:
determining sets of parameter values for parameters of one or more asset generators;
generating assets using the one or more asset generators and the determined sets of parameter values;
generating, using one or more encoding models, asset embeddings for the generated assets; and
storing the asset embeddings and one or more of the generated assets or asset generator information associated with the one or more asset generators.

2. The non-transitory computer-readable storage medium of claim 1, the operations further comprising:
receiving a set of query inputs;
computing a query embedding using the set of query inputs; and
retrieving a set of asset embeddings matching the query embedding, each asset embedding in the set of asset embeddings being associated with a corresponding asset and corresponding asset generator information.

3. The non-transitory computer-readable storage medium of claim 2, wherein the corresponding asset generator information for an asset embedding further comprises an asset generator ID and a set of parameter values, the asset associated with the asset embedding being enabled to be generated using an asset generator with the asset generator ID and the set of parameter values.

4. The non-transitory computer-readable storage medium of claim 3, the operations further comprising:
displaying, via a user interface (UI), the retrieved assets associated with the set of retrieved asset embeddings matching the query embedding; and
upon receiving, via the UI, a user selection of an asset associated with an asset embedding of the set of retrieved asset embeddings:
retrieving the asset generator ID and corresponding set of parameter values associated with the asset embedding; and
upon detecting a user editing operation associated with the asset:
updating the set of parameter values based on the user editing operation; and
storing the updated set of parameter values and the edited asset.

5. The non-transitory computer-readable storage medium of claim 4, the operations further comprising:
upon retrieving the asset generator ID and corresponding set of parameter values associated with the asset embedding:
displaying, in the UI, the asset and the corresponding set of parameter values; and
upon receiving one or more user updates to the corresponding set of parameter values:
storing the updated set of parameter values;
generating, using the asset generator ID and the updated set of parameter values, an updated asset; and
storing the updated asset associated with one or more of the asset generator ID and the updated set of parameter values.

6. The non-transitory computer-readable storage medium of claim 2, wherein the query inputs comprise one or more of at least an image input or a natural language (NL) input.

7. The non-transitory computer-readable storage medium of claim 2, further comprising:
receiving one or more weights, each weight associated with a query input of the set of query inputs; and wherein
computing a query embedding using the set of query inputs further comprises:
generating query input embeddings based on the set of query inputs and one or more encoding models; and
generating the query embedding based on the query input embeddings, the one or more weights, and a combination function.

8. The non-transitory computer-readable storage medium of claim 1, wherein generating asset embeddings for the generated assets further comprises:
generating an asset representation for each asset using a representation model; and
generating, using the one or more encoding models, an asset embedding corresponding to the asset representation for each asset.

9. The non-transitory computer-readable storage medium of claim 8, wherein the representation model is one of at least a shaded rendering model, a stylized rendering model, or a text captioning model.

10. The non-transitory computer-readable storage medium of claim 1, wherein the one or more encoding models are joint image and text embedding models.

11. A method comprising:
determining, at a computing device, sets of parameter values for parameters of one or more asset generators;
generating assets using the one or more asset generators and the determined sets of parameter values;
generating, using one or more encoding models, asset embeddings for the generated assets; and
storing the asset embeddings and one or more of the generated assets or asset generator information associated with the one or more asset generators.

12. The method of claim 11, further comprising:
receiving a set of query inputs;
computing a query embedding using the set of query inputs; and
retrieving a set of asset embeddings matching the query embedding, each asset embedding in the set of asset embeddings being associated with a corresponding asset and corresponding asset generator information.

13. The method of claim 12, wherein the corresponding asset generator information for an asset embedding further comprises an asset generator ID and a set of parameter values, the asset associated with the asset embedding being enabled to be generated using an asset generator with the asset generator ID and the set of parameter values.

14. The method of claim 13, further comprising:
displaying, via a user interface (UI), the retrieved assets associated with the set of retrieved asset embeddings matching the query embedding; and
upon receiving, via the UI, a user selection of an asset associated with an asset embedding of the set of retrieved asset embeddings:
retrieving the asset generator ID and corresponding set of parameter values associated with the asset embedding; and
upon detecting a user editing operation associated with the asset:
updating the set of parameter values based on the user editing operation; and
storing the updated set of parameter values and the edited asset.

15. The method of claim 14, further comprising:
upon retrieving the asset generator ID and corresponding set of parameter values associated with the asset embedding:
displaying, in the UI, the asset and the corresponding set of parameter values; and
upon receiving one or more user updates to the corresponding set of parameter values:
storing the updated set of parameter values;
generating, using the asset generator ID and the updated set of parameter values, an updated asset; and
storing the updated asset associated with one or more of the asset generator ID and the updated set of parameter values.

16. The method of claim 12, wherein the query inputs comprise one or more of at least an image input or a natural language (NL) input.

17. The method of claim 12, further comprising:
receiving one or more weights, each weight associated with a query input of the set of query inputs; and wherein
computing a query embedding using the set of query inputs further comprises:
generating query input embeddings based on the set of query inputs and one or more encoding models; and
generating the query embedding based on the query input embeddings, the one or more weights, and a combination function.

18. The method of claim 11, wherein generating asset embeddings for the generated assets further comprises:
generating an asset representation for each asset using a representation model; and
generating, using the one or more encoding models, an asset embedding corresponding to the asset representation for each asset.

19. The method of claim 18, wherein the representation model is one of at least a shaded rendering model, a stylized rendering model, or a text captioning model.

20. A system comprising:
one or more computer processors;
one or more computer memories; and
a set of instructions stored in the one or more computer memories, the set of instructions configuring the one or more computer processors to perform operations, the operations comprising:
determining sets of parameter values for parameters of one or more asset generators;
generating assets using the one or more asset generators and the determined sets of parameter values;
generating, using one or more encoding models, asset embeddings for the generated assets; and
storing the asset embeddings and one or more of the generated assets or asset generator information associated with the one or more asset generators.

21. A non-transitory computer-readable storage medium storing instructions that, when executed by at least one processor, cause the at least one processor to perform operations comprising:
determining parametrization settings for one or more asset generators, the one or more asset generators being associated with a plurality of parametrization schemes;
generating assets using the one or more asset generators and the parametrization settings;
generating, using an encoding model, asset embeddings corresponding to the assets, the asset embeddings using a common embedding space;
storing the asset embeddings and asset information associated with the one or more asset generators; and
upon receiving query inputs, generating a query embedding in the common embedding space based on the query inputs; and
retrieving a set of asset embeddings relevant to the query embedding, each asset embedding in the set of asset embeddings being associated with corresponding asset information for a respective asset generator of the one or more asset generators.
